(19) United States
(12) Patent Application Publication
(10) Pub. No.: US 2026/0031959 A1
(43) Pub. Date: Jan. 29, 2026

(54) CONSTELLATION-BASED RESOURCE ALLOCATION FOR SENSING AND COMMUNICATION

(71) Applicant: QUALCOMM INCORPORATED, San Diego, CA (US)

(72) Inventors: Stelios Stefanatos, San Diego, CA (US); Gene Wesley Marsh, San Diego, CA (US); Preeti Kumari, San Diego, CA (US); Kapil Gulati, Belle Mead, NJ (US); Junyi Li, Greentown, PA (US)

(21) Appl. No.: 18/995,068

(22) PCT Filed: Aug. 23, 2023
(86) PCT No.: PCT/US2023/030899

§ 371 Date: Jan. 15, 2025

(30) Foreign Application Priority Data
Sep. 19, 2022 (GR) 20220100761

(51) Int. Cl. H04L 5/00; H04L 1/00

(52) U.S. Cl. CPC H04L 5/0057; H04L 1/0003; H04L 1/0009

(57) ABSTRACT

A wireless device may modulate a first portion of data of a transport block associated with a joint communication and sensing (JCS) waveform according to a first modulation scheme of a set of modulation schemes for sensing. The wireless device may modulate a second portion of data of the transport block according to a second modulation scheme. The wireless device may map the modulated first portion of data to a first set of resource elements associated with sensing and may map the second portion of data to a second set of resource elements associated with data communications. The wireless device may transmit the transport block including the mapped first and second portions of data via the JCS waveform. In some cases, the wireless device may transmit the transport block according to one or more parameters of a configuration for the JCS waveform.

### CROSS REFERENCE

This application is a 371 National Stage of PCT Application No. PCT/US2023/030899, filed on Aug. 23, 2023, entitled “CONSTELLATION-BASED RESOURCE ALLOCATION FOR SENSING AND COMMUNICATION”, which claims the benefit of Greece patent application Ser. No. 20/220,100761 by STEFANATOS, et al., entitled “CONSTELLATION-BASED RESOURCE ALLOCATION FOR SENSING AND COMMUNICATION,” filed Sep. 19, 2022, assigned to the assignee hereof, and the disclosure of both are expressly incorporated by reference in their entirety herein.

### FIELD OF TECHNOLOGY

The following relates to wireless communications, including constellation-based resource allocation for sensing and communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A wireless communications system may support sensing (e.g., radar) applications, in which a sensing device may reflect signaling off of a target (e.g., an opaque object) to determine one or more properties associated with the target. For example, in monostatic sensing, a sensing device may transmit a waveform in the direction of a target. The target may reflect the waveform, which may be received by the sensing device. The sensing device may determine a distance, angle, velocity, or other parameter(s) of the target based on the received waveform. In some cases, a sensing device may transmit both radar signaling and communication-based signaling using a same waveform configuration, which may be referred to as joint communication and sensing (JCS). In some cases, achievable resolution and accuracy of sensing may be limited by communication parameters used to transmit a JCS waveform.

### SUMMARY

The described techniques relate to improved methods, systems, devices, and apparatuses that support constellation-based resource allocation for sensing and communication. For example, the described techniques provide for a transmitting device to utilize different modulation schemes for respective portions of data of a transport block to be transmitted via a set of resource elements (REs) associated with a joint communication and sensing (JCS) waveform. The transmitting device may modulate a first portion of data according to a first modulation scheme and a second portion of data according to a second modulation scheme, where the first modulation scheme is a modulation scheme associated with sensing. The transmitting device may map the first portion of data to a first subset of REs of the set of REs that are associated with sensing. Further, the transmitting device may map the second portion of data to a second subset of REs of the set of REs that are associated with data communications. The transmitting device may transmit, to a receiving device, the transport block including the mapped first portion of data and second portion of data, and the receiving device may demodulate the transport block based on the first modulation scheme and the second modulation scheme. In some examples, the transmitting device may perform a sensing procedure using the first subset of REs.

A method for wireless communications at a wireless device is described. The method may include modulating a first portion of data of a transport block associated with a JCS waveform in accordance with a modulation scheme for sensing, mapping the modulated first portion of data to a first set of REs associated with sensing, mapping a second portion of data to a second set of REs associated with data communications, and transmitting the transport block including the mapped first portion of data and second portion of data via the JCS waveform.

An apparatus for wireless communications at a wireless device is described. The apparatus may include a processor, memory coupled with the processor, and instructions stored in the memory. The instructions may be executable by the processor to cause the apparatus to modulate a first portion of data of a transport block associated with a JCS waveform in accordance with a modulation scheme for sensing, map the modulated first portion of data to a first set of REs associated with sensing, map a second portion of data to a second set of REs associated with data communications, and transmit the transport block including the mapped first portion of data and second portion of data via the JCS waveform.

Another apparatus for wireless communications at a wireless device is described. The apparatus may include means for modulating a first portion of data of a transport block associated with a JCS waveform in accordance with a modulation scheme for sensing, means for mapping the modulated first portion of data to a first set of REs associated with sensing, means for mapping a second portion of data to a second set of REs associated with data communications, and means for transmitting the transport block including the mapped first portion of data and second portion of data via the JCS waveform.

A non-transitory computer-readable medium storing code for wireless communications at a wireless device is described. The code may include instructions executable by a processor to modulate a first portion of data of a transport block associated with a JCS waveform in accordance with a modulation scheme for sensing, map the modulated first portion of data to a first set of REs associated with sensing, map a second portion of data to a second set of REs associated with data communications, and transmit the transport block including the mapped first portion of data and second portion of data via the JCS waveform.

In some examples of the method, apparatuses, and non-transitory computer-readable medium described herein, transmitting the transport block may include operations, features, means, or instructions for transmitting the transport block in accordance with one or more parameters of a configuration for the JCS waveform.

In some examples of the method, apparatuses, and non-transitory computer-readable medium described herein, the one or more parameters may include a resource element pattern for the first set of resource elements, and mapping the modulated first portion of data may include operations, features, means, or instructions for mapping the modulated first portion of the data to the first set of REs according to the RE pattern.

In some examples of the method, apparatuses, and non-transitory computer-readable medium described herein, the one or more parameters include a transmit power for the first set of REs and the method, apparatuses, and non-transitory computer-readable medium may include further operations, features, means, or instructions for transmitting the first portion of data according to the transmit power and transmitting the second portion of data according to a second transmit power different than the transmit power.

Some examples of the method, apparatuses, and non-transitory computer-readable medium described herein may further include operations, features, means, or instructions for modulating the second portion of data in accordance with a second modulation scheme for data communications, the second modulation scheme being different than the modulation scheme, where mapping the second portion of data to the second set of REs may be based on the second modulation scheme.

In some examples of the method, apparatuses, and non-transitory computer-readable medium described herein, the wireless device is a first wireless device. Some examples of the method, apparatuses, and non-transitory computer-readable medium described herein may further include operations, features, means, or instructions for transmitting, to a second wireless device, at least one message indicating one or more parameters of a configuration for the JCS waveform, the one or more parameters including the modulation scheme, a transmit power for the first set of REs, a transmit power for the second set of REs, a RE pattern for the first set of REs, a quantity of time domain resources for the configuration, a periodicity for the configuration, or a combination thereof and transmitting the transport block via the JCS waveform in accordance with the configuration and the one or more parameters.

In some examples of the method, apparatuses, and non-transitory computer-readable medium described herein, transmitting the at least one message may include operations, features, means, or instructions for transmitting radio resource control (RRC) signaling, downlink control information (DCI), sidelink control information (SCI), a media access control (MAC) control element (MAC-CE), or a combination thereof.

In some examples of the method, apparatuses, and non-transitory computer-readable medium described herein, transmitting the at least one message may include operations, features, means, or instructions for transmitting a first message indicating a first subset of the one or more parameters and transmitting a second message indicating a second subset of the one or more parameters.

In some examples of the method, apparatuses, and non-transitory computer-readable medium described herein, transmitting the at least one message may include operations, features, means, or instructions for transmitting an indication of a table corresponding to the one or more parameters.

In some examples of the method, apparatuses, and non-transitory computer-readable medium described herein, the at least one message further indicates a time duration for which the configuration may be used, a system frame number corresponding to an end time of the configuration, or a combination thereof.

In some examples of the method, apparatuses, and non-transitory computer-readable medium described herein, the wireless device is a first wireless device. Some examples of the method, apparatuses, and non-transitory computer-readable medium described herein may further include operations, features, means, or instructions for updating at least one parameter of the one or more parameters of the configuration and transmitting, to the second wireless device, a signal indicating the updated at least one parameter.

Some examples of the method, apparatuses, and non-transitory computer-readable medium described herein may further include operations, features, means, or instructions for transmitting, to a second wireless device, a signal indicating that the transport block may be transmitted in accordance with a configuration for the JCS waveform and indicating one or more parameters supported by the wireless device for the configuration.

Some examples of the method, apparatuses, and non-transitory computer-readable medium described herein may further include operations, features, means, or instructions for receiving, from the second wireless device, a message indicating whether the second wireless device supports the configuration for the JCS waveform.

In some examples of the method, apparatuses, and non-transitory computer-readable medium described herein, the wireless device is a first wireless device, and the message indicates that the second wireless device supports the configuration for the JCS waveform, and indicates a set of parameters supported by the second wireless device for the configuration, and where transmitting the transport block may include operations, features, means, or instructions for transmitting the transport block based on the set of parameters supported by the second wireless device.

In some examples of the method, apparatuses, and non-transitory computer-readable medium described herein, the wireless device is a first wireless device. Some examples of the method, apparatuses, and non-transitory computer-readable medium described herein may further include operations, features, means, or instructions for receiving, from a second wireless device, a message indicating one or more preferences of the second wireless device for the JCS waveform, where the transport block may be transmitted in accordance with the one or more preferences based on receiving the message.

In some examples of the method, apparatuses, and non-transitory computer-readable medium described herein, receiving the message may include operations, features, means, or instructions for receiving RRC signaling or a feedback message.

In some examples of the method, apparatuses, and non-transitory computer-readable medium described herein, the wireless device is a first wireless device, and transmitting the transport block may include operations, features, means, or instructions for transmitting the transport block via a communication link between the first wireless device and a second wireless device based on a quality of service associated with the communication link.

Some examples of the method, apparatuses, and non-transitory computer-readable medium described herein may further include operations, features, means, or instructions for receiving control signaling indicating a mapping between one or more quality of service values and one or more parameters for transmitting the JCS waveform, where transmitting the transport block may be based on the mapping.

Some examples of the method, apparatuses, and non-transitory computer-readable medium described herein may further include operations, features, means, or instructions for refraining from mapping the modulated first portion of data to a RE of the first set of REs based on the RE overlapping with a reference signal RE for transmitting a reference signal.

Some examples of the method, apparatuses, and non-transitory computer-readable medium described herein may further include operations, features, means, or instructions for performing a sensing procedure using the reference signal RE and the first set of REs.

Some examples of the method, apparatuses, and non-transitory computer-readable medium described herein may further include operations, features, means, or instructions for performing a sensing procedure using the first set of REs.

In some examples of the method, apparatuses, and non-transitory computer-readable medium described herein, the modulation scheme is from a set of modulation schemes, the set of modulation schemes including at least one of a phase shift keying (PSK) modulation scheme, a quadrature phase shift keying (QPSK) modulation scheme, and a constant-modulus modulation scheme.

A method for wireless communications at a wireless device is described. The method may include receiving, via a JCS waveform, a transport block including a first portion of data and a second portion of data, the first portion of data received via a first set of REs associated with sensing and the second portion of data received via a second set of REs associated with data communications, the first portion of data being modulated in accordance with a modulation scheme for sensing and demodulating the first portion of data and the second portion of data based on the modulation scheme.

An apparatus for wireless communications at a wireless device is described. The apparatus may include a processor, memory coupled with the processor, and instructions stored in the memory. The instructions may be executable by the processor to cause the apparatus to receive, via a JCS waveform, a transport block including a first portion of data and a second portion of data, the first portion of data received via a first set of REs associated with sensing and the second portion of data received via a second set of REs associated with data communications, the first portion of data being modulated in accordance with a modulation scheme for sensing, and demodulating the first portion of data and the second portion of data based on the modulation scheme.

Another apparatus for wireless communications at a wireless device is described. The apparatus may include means for receiving, via a JCS waveform, a transport block including a first portion of data and a second portion of data, the first portion of data received via a first set of REs associated with sensing and the second portion of data received via a second set of REs associated with data communications, the first portion of data being modulated in accordance with a modulation scheme for sensing and means for demodulating the first portion of data and the second portion of data based on the modulation scheme.

A non-transitory computer-readable medium storing code for wireless communications at a wireless device is described. The code may include instructions executable by a processor to receive, via a JCS waveform, a transport block including a first portion of data and a second portion of data, the first portion of data received via a first set of REs associated with sensing and the second portion of data received via a second set of REs associated with data communications, the first portion of data being modulated in accordance with a modulation scheme for sensing and demodulate the first portion of data and the second portion of data based on the modulation scheme.

In some examples of the method, apparatuses, and non-transitory computer-readable medium described herein, demodulating the first portion of data and the second portion of data may include operations, features, means, or instructions for demodulating the first portion of data according to the modulation scheme and demodulating the second portion of data according to the second modulation scheme.

In some examples of the method, apparatuses, and non-transitory computer-readable medium described herein, the wireless device is a first wireless device. Some examples of the method, apparatuses, and non-transitory computer-readable medium described herein may further include operations, features, means, or instructions for receiving, from a second wireless device, at least one message indicating one or more parameters of a configuration for the JCS waveform, the one or more parameters including the modulation scheme, a transmit power for the first set of REs, a transmit power for the second set of REs, a RE pattern for the first set of REs, a quantity of time domain resources for the configuration, a periodicity for the configuration, or a combination thereof and receiving the transport block via the JCS waveform in accordance with the configuration and the one or more parameters.

In some examples of the method, apparatuses, and non-transitory computer-readable medium described herein, receiving the transport block may include operations, features, means, or instructions for receiving the first portion of data via the first set of REs in accordance with the RE pattern.

In some examples of the method, apparatuses, and non-transitory computer-readable medium described herein, receiving the at least one message may include operations, features, means, or instructions for receiving RRC signaling, DCI, SCI, a MAC-CE, or a combination thereof.

In some examples of the method, apparatuses, and non-transitory computer-readable medium described herein, receiving the at least one message may include operations, features, means, or instructions for receiving a first message indicating a first subset of the one or more parameters and receiving a second message indicating a second subset of the one or more parameters.

In some examples of the method, apparatuses, and non-transitory computer-readable medium described herein, receiving the at least one message may include operations, features, means, or instructions for receiving an indication of a table corresponding to the one or more parameters.

In some examples of the method, apparatuses, and non-transitory computer-readable medium described herein, the at least one message further indicates a time duration for which the configuration may be used, a system frame number corresponding to an end time of the configuration, or a combination thereof.

In some examples of the method, apparatuses, and non-transitory computer-readable medium described herein, the wireless device is a first wireless device. Some examples of the method, apparatuses, and non-transitory computer-readable medium described herein may further include operations, features, means, or instructions for receiving, from a second wireless device, a signal indicating that the transport block may be received via the JCS waveform and indicating one or more parameters supported by the second wireless device for the JCS waveform.

Some examples of the method, apparatuses, and non-transitory computer-readable medium described herein may further include operations, features, means, or instructions for transmitting, to the second wireless device, a message indicating whether the first wireless device supports the JCS waveform.

In some examples of the method, apparatuses, and non-transitory computer-readable medium described herein, the message indicates that the first wireless device supports the JCS waveform and indicates a set of parameters supported by the first wireless device for the JCS waveform.

In some examples of the method, apparatuses, and non-transitory computer-readable medium described herein, the wireless device is a first wireless device. Some examples of the method, apparatuses, and non-transitory computer-readable medium described herein may further include operations, features, means, or instructions for transmitting, to a second wireless device, a message indicating one or more preferences of the first wireless device for the JCS waveform.

In some examples of the method, apparatuses, and non-transitory computer-readable medium described herein, transmitting the message may include operations, features, means, or instructions for transmitting RRC signaling or a feedback message.

In some examples of the method, apparatuses, and non-transitory computer-readable medium described herein, the modulation scheme is from a set of modulation schemes for sensing, the set of modulation schemes including at least one of a PSK modulation scheme, a QPSK modulation scheme, and a constant-modulus modulation scheme.

### BRIEF DESCRIPTION OF THE DRAWINGS

FIG. 1 illustrates an example of a wireless communications system that supports constellation-based resource allocation for sensing and communication in accordance with one or more aspects of the present disclosure.

FIG. 2 illustrates an example of a wireless communications system that supports constellation-based resource allocation for sensing and communication in accordance with one or more aspects of the present disclosure.

FIG. 3 illustrates an example of a resource allocation configuration that supports constellation-based resource allocation for sensing and communication in accordance with one or more aspects of the present disclosure.

FIG. 4 illustrates an example of a process flow that supports constellation-based resource allocation for sensing and communication in accordance with one or more aspects of the present disclosure.

FIGS. 5 and 6 show block diagrams of devices that support constellation-based resource allocation for sensing and communication in accordance with one or more aspects of the present disclosure.

FIG. 7 shows a block diagram of a communications manager that supports constellation-based resource allocation for sensing and communication in accordance with one or more aspects of the present disclosure.

FIG. 8 shows a diagram of a system including a UE that supports constellation-based resource allocation for sensing and communication in accordance with one or more aspects of the present disclosure.

FIG. 9 shows a diagram of a system including a network entity that supports constellation-based resource allocation for sensing and communication in accordance with one or more aspects of the present disclosure.

FIGS. 10 through 13 show flowcharts illustrating methods that support constellation-based resource allocation for sensing and communication in accordance with one or more aspects of the present disclosure.

### DETAILED DESCRIPTION

Wireless devices (user equipment (UE), network entities, etc.) may use radar, sensing, ranging, and positioning procedures to identify, track, or locate target objects, and to determine properties or attributes of target objects such as direction, velocity, and the like. For instance, a wireless device may transmit a waveform in one or more directions and may monitor for reflections of the waveform. The waveform may reflect off one or more objects and be received back at a receiver of the wireless device after a time delay. The wireless device may detect or otherwise identify target objects based on the received waveform. For example, the time delay between transmission and reception may be proportional to a range between the wireless device and a detected object off of which the waveform reflects. In some examples, a sensing procedure (which may include or be an example of a ranging procedure, a positioning procedure, or the like) may utilize digital waveforms, such as orthogonal frequency-division multiplexing (OFDM) based waveforms.

In joint communication and sensing (JCS) applications, also referred to as a joint communication and radar (JCR) applications, a common transmitter or receiver may be used for both communication and radar functionalities, and communication waveforms (such as OFDM) may also be used for radar sensing. That is, rather than using separate waveforms for data communications and sensing procedures, which may reduce communications throughput (e.g., as resources used for a sensing waveform are no longer available for data communications), JCS applications may use a same (e.g., common) waveform to both communicate data and perform sensing. For example, a transmitting device may transmit a JCS waveform carrying data information to a receiving device, where the JCS waveform is also used for a sensing procedure (e.g., a monostatic sensing procedure, a bistatic sensing procedure). The transmitting device may monitor for reflections of the JCS waveform and detect target objects. JCS applications may increase efficiency while avoiding throughput costs associated with utilizing dedicated sensing waveforms.

However, communication parameters that provide optimal performance for data communications may conflict with communication parameters associated with improved sensing. For example, in data communications, higher-order modulation schemes may support relatively higher data rates and increased throughput. Such modulation schemes may be associated with increased noise when receiving or processing a sensing signal compared to lower-order or constant modulus modulation schemes, which may degrade performance and accuracy of sensing procedures. Accordingly, a JCS waveform transmitted at a higher-order modulation scheme may achieve relatively high data rates, but may suffer reduced performance in the corresponding sensing procedure. Alternatively, a JCS waveform transmitted at a lower-order or constant modulus modulation scheme may provide improved performance in the sensing procedure, but may have relatively low throughput.

The techniques described herein support configuring communications using JCS waveforms to provide balanced performance in both data communications and sensing. For example, a transmitting device may utilize multiple modulation schemes for a transport block of data to be communicated via a JCS waveform, and may transmit the transport block using a set of resource elements (REs) that includes sensing REs and data REs (e.g., data-only REs that may not be used for sensing). The transmitting device may modulate a first portion of data of the transport block according to a first modulation scheme, where the first modulation scheme is from a set of modulation schemes for sensing, and may map the first portion of data to the sensing REs. The transmitting device may modulate a second portion of data of the transport block according to a second modulation scheme (e.g., different from the first modulation scheme) and may map the second portion of data to the data REs. The sensing REs carrying the first portion of data may be used by the transmitting device to perform a sensing procedure.

In some examples, the transmitting device may implement one or more parameters of a configuration for the JCS waveform, such as a RE pattern for mapping data to the sensing REs, a transmit power for the sensing REs, a transmit power for the data REs, or the like, among other examples. The first and second modulation schemes may also be considered parameters of the configuration. To enable a receiving device to receive and decode the JCS waveform according to the configuration, the transmitting device may indicate the one or more parameters via control signaling. Additionally, in some cases, the transmitting device may indicate (e.g., via control signaling) whether an upcoming transmission is to be transmitted using a JCS waveform employing two different modulation schemes over two sets of REs as described herein. The receiving device may respond to the control signaling by transmitting an indication of support for the configuration, one or more parameters supported by the receiving device, or a combination thereof.

Aspects of the disclosure are initially described in the context of wireless communications systems. Aspects of the disclosure are then discussed with reference to a RE configuration and a process flow. Aspects of the disclosure are further illustrated by and described with reference to apparatus diagrams, system diagrams, and flowcharts that relate to constellation-based resource allocation for sensing and communication.

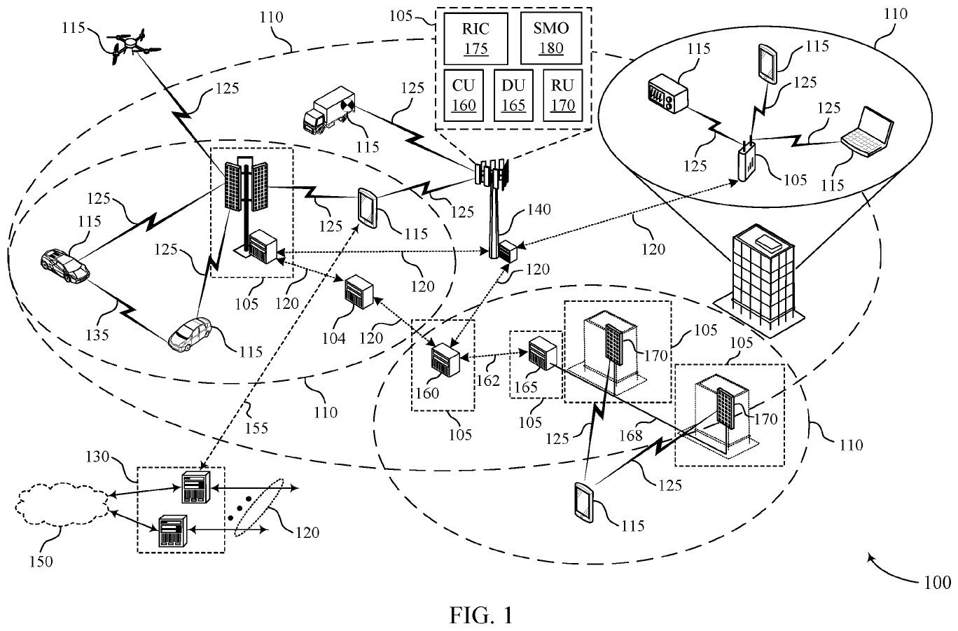

FIG. 1 illustrates an example of a wireless communications system 100 that supports constellation-based resource allocation for sensing and communication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1,F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support constellation-based resource allocation for sensing and communication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a RE may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support radar devices and procedures. For example, a device in the wireless communications system 100, such as a network entity 105, a UE 115, or the like, may reflect radar signaling off of a target (e.g., an opaque object) to determine one or more properties associated with the target. For example, a UE 115 may transmit a waveform in one or more directions. The waveform may be reflected by one or more targets. Upon receiving a reflection of the waveform, the UE 115 may identify one or more physical attributes of a radar target. That is, the reflection of the waveform may indicate the physical attributes of the radar target. Specifically, the UE 115 may determine values for one or more radar measurement parameters (e.g., location, velocity, dimensions, orientation, and uncertainty values for each value) for the radar target.

The performance of a radar may be measured or evaluated based on one or more performance parameters. In some cases, one or more performance parameters may include key performance indicators (KPIs). For example, resolution, estimation accuracy, maximum and minimum range, maximum and minimum doppler shift, field of view (FoV), maximum quantity of targets detected, update rate, and update rate latency may be examples of KPIs. Additionally, or alternatively, signal to interference and noise ratio (SINR) as well as other interference-based parameters may be examples of KPIs. In some cases, a radar may be evaluated using one or more KPIs based on an automotive application and environment.

Similar procedures may be used for sensing, ranging, and positioning applications. For example, devices in the wireless communications system 100 may use positioning reference signals (PRSs) or sounding reference signals (SRSs) to determine parameters (e.g., location, velocity, dimensions, orientation, etc.) for one or more other devices in the wireless communications system 100 or to sense the environment of the wireless communications system 100. In some examples, a sensing procedure (which may include or be an example of a ranging procedure, a positioning procedure, or the like) may utilize digital waveforms, such as OFDM-based waveforms. A monostatic sensing procedure may be performed by a single device that transmits the sensing waveform and monitors for reflections to detect the target object(s). A bistatic sensing procedure may be performed by a transmitter and a receiver that are separated by some distance (e.g., are not co-located). For example, a transmitting device may transmit a sensing waveform and a receiving device (e.g., different from the transmitting device) may receive the sensing waveform and detect one or more target objects. The receiving device may, in some cases, determine information (e.g., range, velocity, or the like) about a target object by performing channel estimation over multiple OFDM symbols (e.g., contiguous OFDM symbols) of the sensing waveform.

In JCS applications, a same waveform may be used to both communicate data and perform sensing, which may increase efficiency in resource utilization. JCS applications may utilize a JCS waveform as part of monostatic sensing, bistatic sensing, or the like. For example, a device in the wireless communications system 100 may transmit data via a JCS waveform and may perform a sensing procedure using the JCS waveform. In some examples, the device may treat the data transmitted via the JCS waveform as a sensing reference signal for a sensing procedure, and may monitor for reflections to detect target objects, perform channel estimation, or the like, among other examples.

For example, the device may calculate (e.g., estimate) a channel impulse response (CIR) based on receiving reflections of the JCS waveform. The device may determine a CIR estimation based on known properties of the JCS waveform, a channel frequency response measured at the device, and any additive noise. The device may calculate a CIR by transforming the channel frequency response to a time domain. However, if the device transmits the JCS waveform using a higher-order modulation scheme, such as a quadrature amplitude modulation (QAM) scheme to achieve a relatively high data rate, the sensing procedure may suffer performance degradation due to increased noise. This noise is introduced when the channel frequency response is estimated and the received sensing REs are equalized by the (higher order) constellation symbols transmitted over the REs. That is, higher-order modulation schemes may be associated with lower signal-to-noise ratios (SNR), which may make accurate channel estimation difficult. As illustrated in Table 1 below, transmissions using higher orders of QAM schemes may be associated with increased noise as compared to transmissions using a constant-modulus modulation scheme (e.g., QPSK), which may reduce accuracy in sensing. It is noted that while Table 1 corresponds to zero-forcing equalization, similar SNR degradation may occur using other types of equalization.

TABLE 1

| | SNR LOSS |
|---|---|
| | Compared to |
| QAM Order | QPSK |
| 16 | 2.76 dB |
| 64 | 4.29 dB |
| 256 | 5.36 dB |
| 1024 | 6.20 dB |
| 4096 | 6.90 dB |

Improved sensing performance may be achieved with lower-order or constant-modulus modulation schemes, though such modulation schemes may reduce the data rate and throughput of the JCS waveform. Accordingly, in some other examples, the JCS waveform may be associated with one or more reference signal REs. For instance, the device may transmit the JCS waveform via a set of REs that includes a first subset of REs used for reference signals and a second subset of REs for carrying data, and may perform the sensing procedure using the reference signal REs. The first subset of REs may be associated with a frequency comb (e.g., a comb-2 pattern, a comb-4 pattern), such that each OFDM symbol of the JCS waveform includes a reference signal RE. The device may modulate the reference signal REs according to a lower-order or constant-modulus modulation scheme to avoid performance degradation. Additionally, sensing procedures may be associated with improved performance and accuracy when reference signal REs have a relatively high density in both the frequency domain and the time domain. In such examples, however, utilizing reference signal REs may reduce throughput, as the reference signal REs are no longer available for data transmission. Thus, the device may determine tradeoffs between sensing performance and communication throughput for JCS waveforms.

In accordance with the techniques described herein, a transmitting device (e.g., a network entity 105, a UE 115) may adjust or configure a JCS waveform to transmit data with a relatively high throughput (e.g., data rate) while maintaining sensing accuracy. The transmitting device may utilize different modulation schemes for different portions of a transport block associated with a JCS waveform, and may perform sensing based on data of the transport block transmitted via the JCS waveform (e.g., instead of performing sensing based on reference signal REs associated with the JCS waveform). For example, the transmitting device may transmit data of a transport block via the JCS waveform such that a first set of REs is associated with sensing, and data mapped to the first set of REs is modulated according to a first modulation scheme. A second set of REs may be associated with data communications, and the transmitting device may modulate data mapped to the second set of REs according to a second modulation scheme. The first modulation scheme may support improved performance in a sensing procedure performed by the transmitting device using the first set of REs. For example, the first modulation scheme may be a constant-modulus modulation scheme or a lower-order modulation scheme. The second modulation scheme may be a relatively higher-order modulation scheme that may support higher data rates, so that the transmitting device may transmit data over the second set of REs with a relatively high throughput. By multiplexing modulation schemes within a same transport block of a JCS waveform, the transmitting device may achieve desired performance outcomes for both communications and sensing.

Additionally, in some cases, the transmitting device may select one or more parameters (e.g., waveform parameters) for a configuration for the JCS waveform (e.g., a JCS waveform configuration). The one or more parameters may include, but are not limited to, the first modulation scheme, the second modulation scheme, an RE pattern for the first set of REs, a transmit power for the first set of REs, a transmit power for the second set of REs, a quantity of time domain resources for the configuration, a periodicity for the configuration, a time duration for the configuration, or the like, among other examples. To enable a receiving device to successfully receive and decode the JCS waveform, the transmitting device may transmit an indication of the one or more parameters to the receiving device, which may monitor for the JCS waveform in accordance with the one or more parameters. That is, the transmitting device may generate and transmit the JCS waveform in accordance with the indicated waveform parameters. The receiving device may receive, demodulate, and decode the JCS waveform based on the indicated waveform parameters.

In some examples, the transmitting device and the receiving device may exchange capability information associated with JCS waveform parameters. For example, the transmitting device may indicate, to the receiving device, a capability of the transmitting device to communicate using JCS waveforms and one or more JCS waveform parameters supported by the transmitting device. In response to the indication, the receiving device may transmit a message indicating a capability of the receiving device to support JCS waveforms and one or more JCS waveform parameters supported by the receiving device, such that the transmitting device may consider the capabilities of the receiving device when determining a configuration (e.g., selecting one or more parameters) for a JCS waveform.

Additionally, or alternatively, the receiving device may determine and indicate one or more preferred JCS waveform parameters based on the capability of the receiving device and, in some cases, based on a tradeoff associated with the preferred JCS waveform parameters. For example, some waveform parameters may be associated with increased power consumption, reduced data throughput, or the like, and the receiving device may select the preferred waveform parameters accordingly. The receiving device may indicate the preferred waveform parameters to the transmitting device, which may configure the JCS waveform based on the preferred waveform parameters.

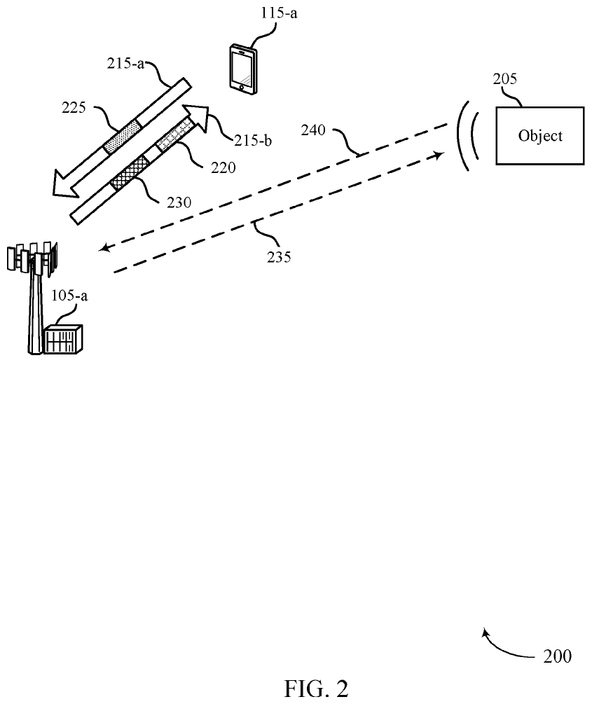

FIG. 2 illustrates an example of a wireless communications system 200 that supports constellation-based resource allocation for sensing and communication in accordance with one or more aspects of the present disclosure. For example, the wireless communications system 200 may include a network entity 105-a and a UE 115-a, which may be examples of corresponding devices as described with reference to FIG. 1. The network entity 105-a and the UE 115-a may communicate over communication links 215, which may be examples of communication links 125 as described with reference to FIG. 1. For example, the wireless communications system 200 may include an uplink communication link 215-a and a downlink communication link 215-b, which may be examples of communication links 125. The uplink communication link 215-a may include or be an example of one or more uplink channels, such as a physical uplink shared channel (PUSCH), a physical uplink control channel (PUCCH), or the like. The downlink communication link 215-b may include or be an example of one or more downlink channels, such as a physical downlink shared channel (PDSCH), a physical downlink control channel (PDCCH), or the like.

Although described as communications between the UE 115-a and the network entity 105-a, any type or quantity of devices may implement the techniques described herein (e.g., multiple UEs 115, IoT devices, roadside units (RSUs), network entities 105, centralized controller nodes, or any combination thereof, among other examples of wireless devices). For example, although FIG. 2 illustrates a monostatic sensing procedure performed with the network entity 105-a as a transmitting device and the UE 115-a as a receiving device, any device or type of device may act as a transmitting device or a receiving device. For example, the monostatic sensing procedure may be performed between two UEs 115 via a sidelink channel (e.g., a physical sidelink shared channel (PSSCH)), between two network entities 105, or the like, among other examples, or the UE 115-a may act as a transmitting device and the network entity 105-a may act as a receiving device. Further, the techniques described herein may be extended to bistatic or other sensing procedures using any quantity of devices. Additionally, although the examples herein refer to sensing procedures, the described methods and techniques may be applied for any ranging, positioning, or radar application.

In some cases, the UE 115-a, the network entity 105-a, or both, may be examples of vehicles (e.g., vehicles in a vehicle-to-everything (V2X) network). As described herein, the UE 115-a and the network entity 105-a may each be capable of transmitting and receiving both radar (e.g., sensing) signaling (e.g., for performing sensing, estimating properties associated with nearby objects, or the like) and communication-based signaling (e.g., data and control signaling). For example, the UE 115-a and the network entity 105-a may support JCS waveforms, in which data communicated via a JCS waveform is also used for sensing. That is, some or all of a JCS waveform used for data communications may be treated as a sensing reference signal. In some examples, the network entity 105-a and the UE 115-a may support a configuration for JCS waveforms including one or more waveform parameters, and may exchange signaling to coordinate waveform parameter selection.

In the example of FIG. 2, the network entity 105-a may transmit a message 220 to the UE 115-a to indicate a configuration and one or more parameters for a subsequent JCS waveform (e.g., a JCS waveform 230) to be transmitted by the network entity 105-a. The UE 115-a may transmit, in response to the message 220, a message 225 indicating whether the UE 115-a supports the configuration and the one or more parameters. In some cases, the message 220 may additionally or alternatively indicate one or more waveform parameters supported or preferred by the UE 115-a. The network entity 105-a may transmit the JCS waveform 230 to the UE 115-a in accordance with the configuration. The JCS waveform 230 may be an example of an OFDM-based waveform (e.g., an OFDM-based signal, such as a cyclic prefix OFDM (CP-OFDM) signal), and in some examples, may be an OFDM-based radar waveform. The JCS waveform may include data communications and may be transmitted via a data channel, such as a PDSCH, PUCCH, or PSSCH.

The network entity 105-a may transmit the JCS waveform 230 such that a portion 235 of the JCS waveform 230 reflects off of object 205, and a reflection 240 (e.g., of the JCS waveform 230) is received at the network entity 105-a. In the example of FIG. 2, the portion 235 may be the JCS waveform 230 transmitted by the network entity 105-a, while the reflection 240 may be the JCS waveform 230 as received by the network entity 105-a, e.g., after being reflected off of object 205. The network entity 105-a may perform sensing based on receiving the reflection 240.

For example, the network entity 105-a may calculate or otherwise determine one or more parameters or properties associated with the object 205. The network entity 105-a may determine a location (e.g., position), orientation, dimensions, or the like, of the object 205, a distance or angle between the network entity 105-a and the object 205, a velocity of the object 205, a Doppler or delay associated with the object 205, etc. For example, the network entity 105-a may determine a range between the network entity 105-a and the object 205 based on a path delay associated with the reflection 240. The network entity 105-a may determine a velocity of the object 205 based on determining Doppler shift across symbols (e.g., OFDM symbols) of the reflection 240. In some cases, the network entity 105-a may additionally determine uncertainty values for each parameter or property of the object 205. Additionally, or alternatively, the network entity 105-a may perform channel estimation based on transmitting the JCS waveform 230 and the reflection 240. For example, the network entity 105-a may calculate (e.g., estimate) a channel impulse response (CIR) based on the reflection 240 off of the object 205.

In accordance with the techniques described herein, the network entity 105-a may utilize REs (e.g., time resources, frequency resources) that are dedicated for sensing (e.g., sensing REs) and REs that are dedicated for data (e.g., data-only REs) when transmitting the JCS waveform 230. The network entity 105-a may adjust communications parameters across the sensing REs and the data-only REs to achieve appropriate performance for sensing and data communications, respectively. That is, the network entity 105-a may select parameters for transmitting data over the sensing REs that support improved accuracy and resolution of a sensing procedure, and may select parameters for transmitting data over the data-only REs that provide a relatively higher throughput and data rate.

For example, the network entity 105-a may transmit a transport block via the JCS waveform 230, where the transport block includes at least a first portion of data and a second portion of data transmitted over a first set of REs and a second set of REs, respectively. The network entity 105-a may perform sensing based on the first set of REs. Thus, the REs that the network entity 105-a uses to perform sensing (e.g., the first set of REs) may carry data, rather than preconfigured sequences associated with reference signals, which may avoid reduced throughput associated with reference signal REs. Additionally, to prevent sensing performance degradation associated with higher-order modulation schemes, the network entity 105-a may modulate the first portion of data according to a first modulation scheme from a set of modulation schemes for sensing. Further, to avoid reduced data rate and throughput, the network entity 105-amay modulate the second portion of data according to a second modulation scheme (e.g., different from the first modulation scheme) for data communications.

The set of modulation schemes for sensing may include modulation schemes that are associated with relatively low noise, such as QPSK, phase shift keying (PSK), one or more constant-modulus schemes, one or more lower-order modulation schemes (e.g., 16-QAM), or a subset of a higher-order modulation scheme (e.g., a four symbol subset of 64-QAM). In contrast, the second modulation scheme for data communications may be a relatively higher-order modulation scheme, such as 64-QAM, 256-QAM, 1024-QAM, 4096-QAM, or the like, among other examples.

The network entity 105-a may map the modulated first portion of data to the first set of REs and may map the second portion of data to the second set of REs. The network entity 105-a may transmit the transport block including the mapped first and second portions of data via the JCS waveform 230. To perform the sensing procedure, the network entity 105-a may monitor the first set of REs for the reflection 240. The network entity 105-a may perform a channel estimation (e.g., for the communication link 215-a, the communication link 215-b, or both) based on receiving the reflection 240. For instance, the network entity 105-a may perform measurements using the reflection 240 to determine a CIR associated with the channel over which the JCS waveform is transmitted.

In some examples, the network entity 105-a may transmit the JCS waveform 230 and perform sensing periodically, e.g., according to a configured periodicity. For example, the network entity 105-a may transmit a JCS waveform 230 according to a sensing period, which may be determined or adjusted based on an environment of the wireless communications system 200. In relatively fast-changing environments, the network entity 105-a may transmit a JCS waveform 230 more frequently to maintain knowledge of the environment. In other examples, the network entity 105-a may use the JCS waveform 230 to perform sensing in a dynamic manner, such as when tracking a target of interest.

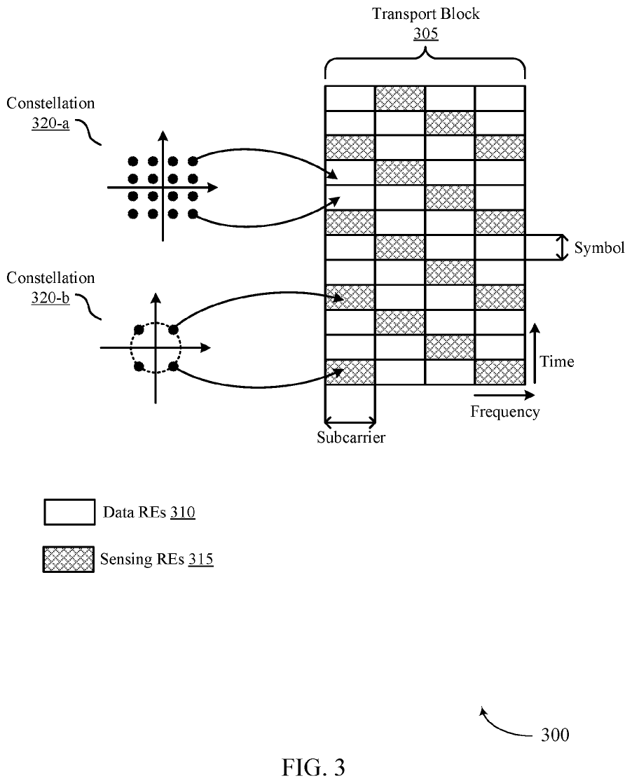

To support successful reception of the JCS waveform 230, the network entity 105-a may transmit the message 220 to inform the UE 115-a of one or more parameters of a configuration for the JCS waveform 230, such that the UE 115-a is able to demodulate and decode the JCS waveform 230 in accordance with the modulation schemes applied by the network entity 105-a. For example, as described in greater detail with reference to FIG. 3, the network entity 105-a may indicate, in the message 220, the first modulation scheme, the second modulation scheme, and an RE pattern associated with the transport block. The RE pattern may indicate which REs are associated with the first set of REs and are thus modulated according to the first modulation scheme. The UE 115-a may, in some examples, assume that any REs not included in the RE pattern belong to the second set of REs and are modulated according to the second modulation scheme. The UE 115-a may demodulate the first portion of data mapped to the first set of REs according to the RE pattern based on the first modulation scheme and may demodulate the second portion of data mapped to the second set of REs based on the second modulation scheme.

The network entity 105-a may, in some cases, transmit the JCS waveform 230 in accordance with a power distribution. The network entity 105-a may transmit the first portion of data over the first set of REs according to a first transmit power and may transmit the second portion of data over the second set of REs according to a second transmit power. To achieve sufficient sensing performance, the network entity 105-a may boost the transmit power of the first set of REs compared to the second set of RES, e.g., the first transmit power may be greater than the second transmit power. The network entity 105-a may indicate the first transmit power, the second transmit power, or both, in the message 220.

In some cases, the network entity 105-a may configure (e.g., pre-configure) the JCS waveform 230 semi-statically via the message 220, which may be an example of an RRC message. The message 220 may indicate the configuration, which may include the first modulation scheme, the second modulation scheme, the first transmit power, the second transmit power, the RE pattern for the first set of REs, or a combination thereof. The network entity 105-a may transmit the message 220 to configure multiple transmissions of the JCS waveform 230, which may be transmitted by the network entity 105-a at regular intervals (e.g., periodically). The message 220 may additionally indicate a periodicity for the configuration, which may correspond to a periodicity for transmitting the JCS waveform 230. Accordingly, the network entity 105-a and the UE 115-a may apply the configuration indicated by the message 220 periodically, which may enable the UE 115-a to receive periodic JCS waveforms 230 without receiving configuration information for every JCS waveform 230. For example, the message 220 may indicate a periodicity such that the UE 115-a assumes that transmissions that are received from the network entity 105-a in accordance with the periodicity are JCS waveforms 230, and may receive the transmissions in accordance with the configuration.

Additionally, or alternatively, the message 220 may indicate a time duration for which the indicated configuration is to be applied. During the time duration, the configuration may be considered active, e.g., transmissions communicated within the time duration may be assumed to be JCS waveforms 230, and the UE 115-b may receive the JCS waveforms 230 in accordance with the configuration. After the time duration, the configuration may be considered inactive, and the UE 115-a may refrain from applying the configuration. For example, the message 220 may indicate a quantity of time domain resources (e.g., slots, symbols, or the like) across which the configuration is to be applied for each periodic instance of the JCS waveform 230. In this example, the network entity 105-a may transmit the JCS waveform such that the first set of REs and the second set of REs span the quantity of time domain resources, and the UE 115-b may apply the configuration for the quantity of time domain resources. In another example, the message 220 may indicate the time duration by indicating an end time or a system frame number (SFN) after which the configuration is inactive. Additionally, or alternatively, the message 220 may indicate a timer, such that expiry of the timer indicates that the configuration should no longer be applied (e.g., the configuration is inactive after the timer expires).

In some examples, the network entity 105-a may transmit one or more additional messages 220 to activate, deactivate, or modify the configuration for the JCS waveform 230. For example, the network entity 105-a may semi-statically configure the UE 115-b with the configuration via the message 220, but the UE 115-a may not apply the configuration until the network entity 105-a transmits a second message 220 indicating activation of the configuration. The second message 220 may be an example of dynamic control signaling, such as DCI, SCI, or the like, that includes a field (e.g., a one-bit field) to indicate that the configuration is active. In some cases, the second message 220 may indicate activation of the configuration for an upcoming transmission (e.g., may indicate that an upcoming transmission is a JCS waveform 230), such as a transmission scheduled by the second message 220. As another example, the network entity 105-a may transmit one or more JCS waveforms 230 in accordance with the configuration until the network entity 105-a transmits a second message 220 indicating that the configuration is inactive (e.g., terminated). Additionally, or alternatively, the network entity 105-a may determine to update (e.g., modify) one or more parameters of the configuration, and may transmit a second message 220 to indicate the updated one or more parameters.

In some cases, the network entity 105-a may semi-statically configure a first subset of parameters of the configuration and may dynamically configure a second subset of parameters of the configuration. The network entity 105-a may transmit the message 220, which may be an example of RRC signaling, to indicate the first subset of parameters, and may transmit a second message 220, which may be an example of DCI, SCI, a MAC control element (MAC-CE), or the like, to indicate the second subset of parameters. For example, the first subset of parameters indicated by the message 220 may include the set of modulation schemes for sensing, and the network entity 105-a may indicate a modulation scheme from the set of modulation schemes to be used for a subsequent JCS waveform 230 via the second message 220.

Alternatively, the network entity 105-a may dynamically indicate the one or more parameters for the configuration for the JCS waveform 230. Here, the message 220 may be an example of DCI, SCI, a MAC-CE, or the like. The network entity 105-a may transmit a message 220 indicating the one or more parameters for each JCS waveform 230 transmitted by the network entity 105-a. For example, the network entity 105-a may transmit the message 220 including DCI scheduling a JCS waveform 230, where the DCI indicates the one or more parameters to be used by the UE 115-a to receive the scheduled JCS waveform 230. In such examples, the message 220 may indicate a table (e.g., a preconfigured table) corresponding to the one or more parameters. For example, each entry in the table may correspond to a parameter of the configuration, where a value of an entry may be mapped to a value of the corresponding parameter.

In some cases, the network entity 105-a may transmit the message 220 to indicate that an intention of the network entity 105-a to apply a configuration (e.g., a JCS configuration) for a subsequent transmission from the network entity 105-a. The network entity 105-a and the UE 115-a may coordinate to determine parameters for the configuration, e.g., based on capability information associated with the network entity 105-a, the UE 115-a, or both. For example, the network entity 105-a may indicate, as part of the message 220, capability information associated with the network entity 105-a for the configuration, such as one or more parameters supported by the network entity 105-a. The UE 115-a may transmit a message 225 in response to the message 220 indicating capability information associated with the UE 115-a, such as whether the UE 115-a supports JCS waveforms or the indicated configuration. The message 225 may be an example of control signaling, such as RRC signaling, or may include or be an example of a feedback message (e.g., a HARQ feedback message).

For instance, the UE 115-a may indicate a capability of the UE 115-a to receive JCS waveforms and may further indicate support for the configuration indicated by the network entity 105-a. In this example, the network entity 105-a may transmit the JCS waveform 230 in accordance with the indicated configuration. Alternatively, the UE 115-a may indicate that the UE 115-a has the capability to receive a JCS waveform 230, but does not support the configuration indicated by the network entity 105-a. In either case, the UE 115-a may include, in the message 225, capability information associated with a set of parameters of the configuration. For instance, the UE 115-a may indicate a set of parameters supported by the UE 115-a for the configuration. In another example, the UE 115-a may indicate preferences of the UE 115-a for the configuration, such as one or more preferred parameters. Here, the UE 115-a may select preferred parameters based on a tradeoff, e.g., associated with the one or more parameters indicated by the network entity 105-a in the message 220.

For example, the UE 115-a may determine that a modulation scheme for sensing indicated in the message 220 is associated with a relatively low data rate. The UE 115-a may be unwilling or unable to sacrifice data rate performance to support the sensing procedure to be performed at the network entity 105-a, and may select a different modulation scheme (e.g., of the set of modulation schemes) for sensing that may be associated with a higher data rate. The UE 115-a may indicate the selected modulation scheme as part of the preferred parameters indicated in the message 225. Other preferred parameters may include an RE pattern for the first set of REs, a transmit power for the first set of REs, a transmit power for the second set of REs, a power distribution between the first set of REs and the second set of REs, or a combination thereof.

The network entity 105-a may consider the message 225 received from the UE 115-a when transmitting the JCS waveform 230. For example, the network entity 105-a may select parameters for the configuration for the JCS waveform 230 that align with capability information indicated by the UE 115-a (e.g., that are supported by the UE 115-a) to ensure that the UE 115-a is able to receive the JCS waveform 230. If the UE 115-a indicates a set of preferred parameters, the network entity 105-a may transmit the JCS waveform 230 in accordance with one or more parameters of the set of preferred parameters. However, if the UE 115-a indicates that the UE 115-a is not capable of supporting JCS waveforms, the network entity 105-a may refrain from transmitting a JCS waveform 230 to the UE 115-a.

Preferences of the UE 115-a may change over time, and in some cases, the UE 115-a may request a reconfiguration of the JCS waveform 230, e.g., via transmission of a second message 225. For example, the UE 115-a may request that the network entity 105-a switch to a different modulation scheme for subsequent JCS waveforms 230, such as a modulation scheme associated with a relatively higher data throughput than a currently-configured modulation scheme. In another example, the UE 115-a may no longer support power boosting of the first set of REs (e.g., associated with sensing) and may request that the network entity 105-a modify the first transmit power, the second transmit power, or both. For instance, the UE 115-a may request that the network entity 105-a apply a same transmit power for both the first set of REs and the second set of REs, or that the network entity 105-a reduce the first transmit power.

In any case, the UE 115-a may identify or otherwise select one or more parameters (e.g., preferred parameters) of the configuration for the JCS waveform 230 to be updated by the network entity 105-a. The UE 115-a may indicate the one or more preferred parameters via control signaling, such as RRC signaling, or via feedback information, such as a feedback message. In the latter example, the UE 115-a may transmit feedback for a JCS waveform 230 and may include, in the feedback message, the one or more preferred parameters. For instance, the UE 115-a may transmit a NACK sequence or an ACK sequence that includes information associated with the one or more preferred parameters.

The network entity 105-a may update one or more parameters of the configuration for the JCS waveform 230 based on the one or more preferred parameters indicated by the UE 115-a. In some examples, the network entity 105-a may transmit a message (e.g., a control signal) to the UE 115-a to indicate the updated parameter(s). The network entity 105-a may transmit subsequent JCS waveforms 230 to the UE 115-a in accordance with the updated parameter(s).

In some examples, the network entity 105-a may transmit the JCS waveform 230 based on a quality of service (QOS) associated with a communication link 215 (e.g., the communication link 215-a, the communication link 215-b) between the UE 115-a and the network entity 105-a. For example, the communication link 215 may be associated with one or more QoS parameters (e.g., QoS requirements), such as a QoS flow identifier (QFI), a priority field value (e.g., indicated via SCI), or the like. The network entity 105-a may determine whether to transmit the JCS waveform 230 according to the configuration based on the one or more QoS parameters. As an example, the network entity 105-a may refrain from transmitting a JCS waveform 230 if the communication link 215 is associated with a relatively high throughput QoS requirement, e.g., if transmitting the JCS waveform 230 according to the first and second modulation schemes may not meet the throughput QoS requirement. Additionally, or alternatively, the network entity 105-a may select one or more parameters for the configuration for the JCS waveform 230 based on the one or more QoS parameters. For example, the network entity 105-a may select an RE pattern for the first set of REs that has a relatively low quantity of REs, or a modulation scheme from the set of modulation schemes, to avoid significant throughput reduction associated with the first set of REs.

FIG. 3 illustrates an example of a resource allocation configuration 300 that supports constellation-based resource allocation for sensing and communication in accordance with one or more aspects of the present disclosure. The resource allocation configuration 300 may be implemented by or may implement aspects of the wireless communications systems 100 and 200. For example, a UE 115 or a network entity 105, as described with reference to FIGS. 1 and 2, may implement aspects of the resource allocation configuration 300 to transmit a JCS waveform in accordance with the techniques described herein.

The resource allocation configuration 300 may be an example of a configuration for a JCS waveform. As described herein, a transmitting device (e.g., a UE, a network entity) may configure a JCS waveform based on one or more waveform parameters. The JCS waveform may be transmitted via a communication link (e.g., PDSCH, PUSCH, PSSCH) on a set of REs (e.g., time and frequency resources), such as a set of symbols and a set of subcarriers, respectively. In accordance with the techniques described herein, the transmitting device may allocate data of a transport block 305 to REs of the JCS waveform based on modulation schemes associated with the JCS waveform. Put another way, the transmitting device may allocate modulated symbols of the transport block 305 to REs based on a constellation from which a modulated symbol originates.

As described with reference to FIG. 2, the one or more waveform parameters may include at least a first modulation scheme, a second modulation scheme, and an RE pattern. The first modulation scheme may be an example of a 16-QAM scheme and may correspond to (e.g., be represented by) a constellation 320-a. The second modulation scheme may be an example of a QPSK scheme and may correspond to (e.g., be represented by) a constellation 320-b. The RE pattern may be an example of a staggered comb-3 pattern. A first subset of REs of the set of REs may be associated with data (e.g., and not sensing) and may be referred to as data REs 310. A second subset of REs of the set of REs may be associated with sensing and may be referred to as sensing REs 315. As illustrated, the RE pattern may be for the sensing REs 315, such that the sensing REs 315 are distributed across the set of REs according to the staggered comb-3 pattern.

The transmitting device may modulate a first portion of data of the transport block 305 according to the first modulation scheme. The transmitting device may map the first portion of data to the data REs 310 based on the first modulation scheme, such that data-bearing symbols of the data REs 310 originate from the constellation 320-a. For example, the transmitting device may allocated a modulated symbol from the constellation 320-a to a data RE 310 of the transport block 305 in accordance with the RE pattern.

The transmitting device may modulate a second portion of data of the transport block 305 according to the second modulation scheme, and may map the second portion of data to the sensing REs 315 based on the second modulation scheme. Accordingly, the transmitting device may obtain data-bearing symbols to be allocated to the sensing REs 315 from the constellation 320-b. That is, the transmitting device may allocate a modulated symbol originating from the constellation 320-b to a sensing RE 315 of the transport block 305 according to the RE pattern.

The transmitting device may transmit the transport block 305 via the JCS waveform based on allocating the data REs 310 and the sensing REs 315 and in accordance with the one or more waveform parameters. A receiving device may receive the transport block 305 and may demodulate the first portion of data and the second portion of data according to the first modulation scheme and the second modulation scheme, respectively. For example, the receiving device may demodulate data transmitted over the data REs 310 based on the first demodulation scheme. The receiving device may demodulate data transmitted over the sensing REs 315 based on the second demodulation scheme.

Additionally, the transmitting device may perform sensing using the sensing REs 315. For example, the transmitting device may monitor for reflections of the JCS waveform transmitted via the sensing REs 315. In some cases, the transmitting device may perform one or more measurements of the sensing REs 315 to obtain a channel estimation for the communication link over which the JCS waveform is transmitted. The transmitting device may calculate or otherwise identify a channel frequency response via the sensing REs 315 and may obtain a CIR based on the channel frequency response.

The RE pattern may be associated with a density of sensing REs 315 corresponding to a quantity of sensing REs 315. A quantity of sensing REs 315 in a frequency domain may correspond to a frequency density for sensing, while a quantity of sensing REs 315 in a time domain may correspond to a time density for sensing. The time density and frequency density indicated by the RE pattern may affect channel estimation or other calculations performed by the transmitting device. A relatively high quantity of sensing REs 315 corresponding to a relatively high density of sensing REs 315 may be associated with improved sensing procedures. For example, an RE pattern associated with a relatively high density of sensing REs 315 in the time domain, the frequency domain, or both may enable a transmitting device to obtain channel measurements from a greater quantity of sensing REs 315, which may provide increased sensing resolution and accuracy.

In some examples, the RE pattern may overlap with another RE pattern, such as a reference signal (e.g., demodulation reference signal (DMRS), phase tracking (PT) reference signal (PT RS)) RE pattern. For instance, a sensing RE 315 associated with the RE pattern illustrated in FIG. 3 may overlap with an RE associated with a DMRS RE pattern. In such examples, the transmitting device may cede the RE to the DMRS RE pattern. That is, the transmitting device may refrain from mapping data of the second portion of data (e.g., from the constellation 320-b) to the sensing RE 315 and may instead transmit a DMRS over the sensing RE 315. In such cases, the transmitting device may include the DMRS as part of the sensing procedure, e.g., may perform sensing based on the DMRS and the other (non-overlapping) sensing REs 315.

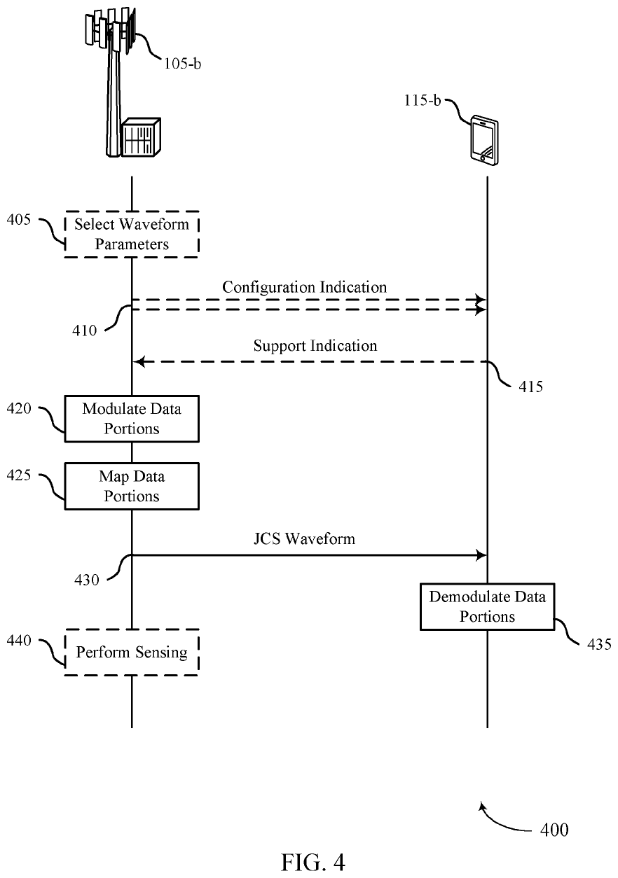

FIG. 4 illustrates an example of a process flow 400 that supports constellation-based resource allocation for sensing and communication in accordance with one or more aspects of the present disclosure. In some examples, process flow 400 may implement aspects of the wireless communications systems 100 and 200 and the resource allocation configuration 300. For example, process flow 400 includes a UE 115-b and a network entity 105-b, which may be examples of corresponding devices described herein. The network entity 105-b may transmit, and the UE 115-b may receive, a transport block via a JCS waveform, where the JCS waveform may implement aspects of the resource allocation configuration 300.

In the following description of process flow 400, the operations between the UE 115-b and the network entity 105-b may be transmitted in a different order than the order shown, or the operations may be performed at different times. Some operations may also be left out of process flow 400, or other operations may be added to process flow 400. While the UE 115-b and the network entity 105-b are shown performing the operations of process flow 400, any wireless device or quantity of devices may perform the operations shown.

At 405, the network entity 105-b may select one or more waveform parameters for the JCS waveform. That is, the network entity 105-b may determine a configuration (e.g., a JCS waveform configuration) for the JCS waveform that includes one or more waveform parameters for transmitting the JCS waveform. The one or more waveform parameters may include a quantity of time domain resources for the configuration, a periodicity for the configuration, a time duration for which the configuration is to be used, a system frame number corresponding to an end time of the configuration, or a combination thereof, among other examples.

Additionally, the network entity 105-b may select or otherwise determine one or more waveform parameters for a first set of REs associated with the transport block, one or more waveform parameters for a second set of REs associated with the transport block, or a combination thereof. The first set of REs may be associated with sensing and the second set of REs may be associated with data communications. The one or more waveform parameters for the first set of REs may include, but are not limited to, an RE pattern, a first modulation scheme, and a first transmit power. The network entity 105-b may select the first modulation scheme from a set of modulation schemes associated with sensing: the set of modulation schemes may include at least one of PSK, QPSK, and a constant-modulus modulation scheme. The one or more waveform parameters for the second set of REs may include, but are not limited to, a second modulation scheme (e.g., different from the first modulation scheme) and a second transmit power (e.g., different from the first transmit power). The second modulation scheme may be for data communications and may be an example of a higher-order modulation scheme, such as QAM.

In some examples, the network entity 105-b may select or otherwise determine the one or more waveform parameters based on a QoS associated with a communication link between the network entity 105-b and the UE 115-b. For example, the network entity 105-b may determine or identify one or more QoS values associated with the communication link, and may select one or more waveform parameters corresponding to the one or more QoS values. In some cases, the network entity 105-b may receive control signaling indicating a mapping between the one or more QoS values and the one or more waveform parameters, and may select the one or more waveform parameters in accordance with the mapping.

At 410, the network entity 105-b may optionally transmit, and the UE 115-b may receive, at least one message indicating the configuration, the one or more waveform parameters, or a combination thereof. For example, the network entity 105-b may transmit a signal (e.g., a control signal) indicating that the transport block is to be transmitted in accordance with the configuration (e.g., the JCS waveform configuration) and indicating one or more parameters (e.g., waveform parameters) supported by the network entity 105-b for the configuration. The indicated one or more parameters may, in some cases, include the one or more waveform parameters selected at 405.

Additionally, or alternatively, the network entity 105-b may transmit the at least one message indicating the one or more waveform parameters selected at 405. In some cases, the network entity 105-b may transmit, as part of the at least one message, an indication of a table corresponding to the one or more waveform parameters selected at 405. In some examples, the at least one message may include or be an example of control signaling, such as RRC signaling, DCI, SCI, a MAC-CE, or a combination thereof. For example, the network entity 105-b may transmit a first message indicating a first subset of the one or more parameters, where the first message is an RRC message. The network entity 105-b may transmit a second message indicating a second subset of the one or more parameters, where the second message is DCI, SCI, or a MAC-CE.

At 415, the UE 115-b may optionally transmit, and the network entity 105-b may receive, a message indicating whether the UE 115-b supports the configuration, the one or more parameters, or both. The message may include or be an example of control signaling (e.g., RRC signaling) or a feedback message (e.g., a HARQ feedback message, such as an ACK or a NACK). For example, the UE 115-b may indicate that the UE 115-b supports the configuration (e.g., indicated at 410) and supports the one or more parameters (e.g., indicated at 410). Alternatively, the UE 115-b may indicate that the UE 115-b supports the configuration and may indicate a set of parameters supported by the UE 115-b for the configuration, which may be different than the one or more parameters indicated by the network entity 105-b at 410. The set of parameters may include a first modulation scheme for the first set of REs, a second modulation scheme for the second set of REs, a transmit power for the first set of REs, a transmit power for the second set of REs, an RE pattern for the first set of REs, a quantity of time domain resources for the configuration, a periodicity for the configuration, or a combination thereof.

Additionally, or alternatively, the UE 115-b may transmit a message indicating one or more preferences of the UE 115-b for the JCS waveform (e.g., for the configuration). For example, the UE 115-b may indicate one or more waveform parameters preferred by the UE 115-b, such as a first modulation scheme for the first set of REs, a second modulation scheme for the second set of REs, a transmit power for the first set of REs, a transmit power for the second set of REs, an RE pattern for the first set of REs, a quantity of time domain resources for the configuration, a periodicity for the configuration, or a combination thereof.

In some cases, the network entity 105-b may select, adjust, or modify the one or more waveform parameters for the configuration for the JCS waveform based on receiving the message(s) at 415. For example, the network entity 105-b may select one or more waveform parameters that the UE 115-b supports, e.g., as indicated by the message received at 415. As another example, the network entity 105-b may have previously selected one or more waveform parameters (e.g., at 405), but may adjust (e.g., update) at least one waveform parameter of the one or more waveform parameters based on the message received at 415, e.g., in accordance with the set of parameters supported or preferred by the UE 115-b. Here, the network entity 105-b may transmit a signal to the UE 115-b indicating the adjusted at least one waveform parameter.

At 420, the network entity 105-b may modulate portions of data of the transport block. The network entity 105-b may modulate a first portion of the data according to the first modulation scheme (e.g., of the set of modulation schemes for sensing). Additionally, the network entity 105-b may modulate a second portion of the data according to the second modulation scheme.

At 425, the network entity 105-b may map the portions of data of the transport block to the first set of REs and the second set of REs. The network entity 105-b may map the modulated first portion of data to the first set of REs based on the first modulation scheme and the first set of REs being for sensing. In some cases, the network entity 105-b may map the modulated first portion of data to the first set of REs in accordance with the RE pattern for the first set of REs. The network entity 105-b may map the second portion of data to the second set of REs based on the second modulation scheme and the second set of REs being associated with data communications.

In some examples, the network entity 105-b may determine that at least one RE of the first set of REs is associated with (e.g., reserved for) a reference signal RE for transmitting a reference signal, such as a DMRS, a PT reference signal, or the like. For example, the at least one RE may overlap with a reference signal RE associated with a reference signal RE pattern. In such cases, the network entity 105-b may refrain from mapping the modulated first portion of data to the at least one RE.

At 430, the network entity 105-b may transmit, and the UE 115-b may receive, the transport block including the mapped first portion of data and the mapped second portion of data via the JCS waveform over the communication link between the network entity 105-b and the UE 115-b. For example, the network entity 105-b may transmit, and the UE 115-b may receive, the transport block via the JCS waveform in accordance with the one or more waveform parameters and the configuration for the JCS waveform. For example, the network entity 105-b may transmit the first portion of data according to a first transmit power and may transmit the second portion of data according to a second transmit power. Additionally, or alternatively, the network entity 105-b may transmit, and the UE 115-b may receive, the transport block based on the one or more QoS values of the communication link, the mapping between the QoS values and the one or more waveform parameters, or a combination thereof.

In some cases, the network entity 105-b may transmit, and the UE 115-b may receive, the transport block via the JCS waveform based on the set of parameters supported by the UE 115-b or the one or more preferences of the UE 115-b, e.g., based on receiving the message at 415.

At 435, the UE 115-b may demodulate the first portion of data and the second portion of data based on at least the first modulation scheme. For example, the UE 115-b may demodulate the first portion of data according to the first modulation scheme and may demodulate the second portion of data according to the second modulation scheme.

At 440, the network entity 105-b may optionally perform a sensing procedure using the first set of REs. For instance, the network entity 105-b may perform channel estimation for the communication link based on the JCS waveform. Additionally, or alternatively, the network entity 105-b monitor for reflections of the JCS waveform (e.g., transmitted at 430). Based on receiving reflections of the JCS waveform, the network entity 105-b may obtain or otherwise calculate parameters (e.g., range, velocity, etc.) associated with one or more target objects off of which the JCS waveform reflected. In some cases, if at least one RE of the first set of REs overlapped with a reference signal RE, the network entity 105-b may perform the sensing procedure using the first set of REs and the reference signal associated with the reference signal RE.

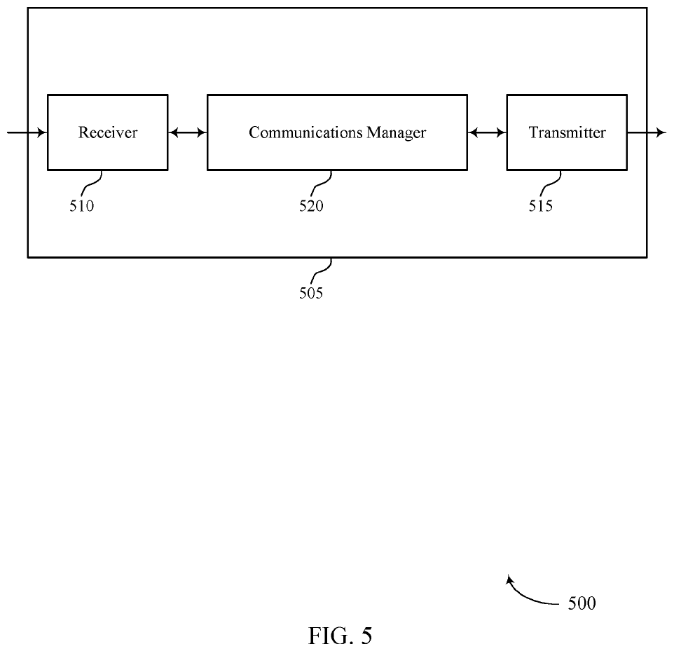

FIG. 5 shows a block diagram 500 of a device 505 that supports constellation-based resource allocation for sensing and communication in accordance with one or more aspects of the present disclosure. The device 505 may be an example of aspects of a UE 115 or a network entity 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to constellation-based resource allocation for sensing and communication). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to constellation-based resource allocation for sensing and communication). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of constellation-based resource allocation for sensing and communication as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a wireless device in accordance with examples as disclosed herein. For example, the communications manager 520 may be configured as or otherwise support a means for modulating a first portion of data of a transport block associated with a JCS waveform in accordance with a modulation scheme for sensing. The communications manager 520 may be configured as or otherwise support a means for mapping the modulated first portion of data to a first set of REs associated with sensing. The communications manager 520 may be configured as or otherwise support a means for mapping a second portion of data to a second set of REs associated with data communications. The communications manager 520 may be configured as or otherwise support a means for transmitting the transport block including the mapped first portion of data and second portion of data via the JCS waveform.

Additionally, or alternatively, the communications manager 520 may support wireless communications at a wireless device in accordance with examples as disclosed herein. For example, the communications manager 520 may be configured as or otherwise support a means for receiving, via a JCS waveform, a transport block including a first portion of data and a second portion of data, the first portion of data received via a first set of REs associated with sensing and the second portion of data received via a second set of REs associated with data communications, the first portion of data being modulated in accordance with a modulation scheme for sensing. The communications manager 520 may be configured as or otherwise support a means for demodulating the first portion of data and the second portion of data based on the modulation scheme.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources and improved coordination between devices. For example, the device 505 may support more efficient utilization of communication resources by transmitting data via a JCS waveform. Accordingly, the device 505 may reduce the processing overhead at the device 505. Additionally, by modulating portions of data for the JCS waveform according to different modulation schemes, the device 505 may improve communications throughput while reducing interference and maintaining sensing accuracy.

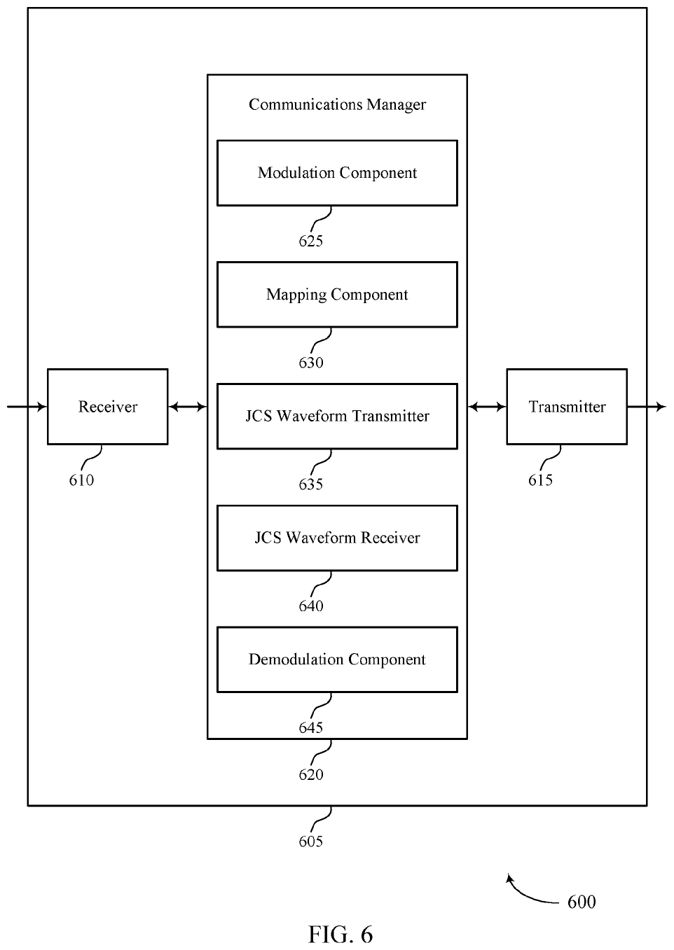

FIG. 6 shows a block diagram 600 of a device 605 that supports constellation-based resource allocation for sensing and communication in accordance with one or more aspects of the present disclosure. The device 605 may be an example of aspects of a device 505, a UE 115, or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to constellation-based resource allocation for sensing and communication). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to constellation-based resource allocation for sensing and communication). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of constellation-based resource allocation for sensing and communication as described herein. For example, the communications manager 620 may include a modulation component 625, a mapping component 630, a JCS waveform transmitter 635, a JCS waveform receiver 640, a demodulation component 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a wireless device in accordance with examples as disclosed herein. The modulation component 625 may be configured as or otherwise support a means for modulating a first portion of data of a transport block associated with a JCS waveform in accordance with a modulation scheme for sensing. The mapping component 630 may be configured as or otherwise support a means for mapping the modulated first portion of data to a first set of REs associated with sensing. The mapping component 630 may be configured as or otherwise support a means for mapping a second portion of data to a second set of REs associated with data communications. The JCS waveform transmitter 635 may be configured as or otherwise support a means for transmitting the transport block including the mapped first portion of data and second portion of data via the JCS waveform.

Additionally, or alternatively, the communications manager 620 may support wireless communications at a wireless device in accordance with examples as disclosed herein. The JCS waveform receiver 640 may be configured as or otherwise support a means for receiving, via a JCS waveform, a transport block including a first portion of data and a second portion of data, the first portion of data received via a first set of REs associated with sensing and the second portion of data received via a second set of REs associated with data communications, the first portion of data being modulated in accordance with a modulation scheme for sensing. The demodulation component 645 may be configured as or otherwise support a means for demodulating the first portion of data and the second portion of data based on the modulation scheme.

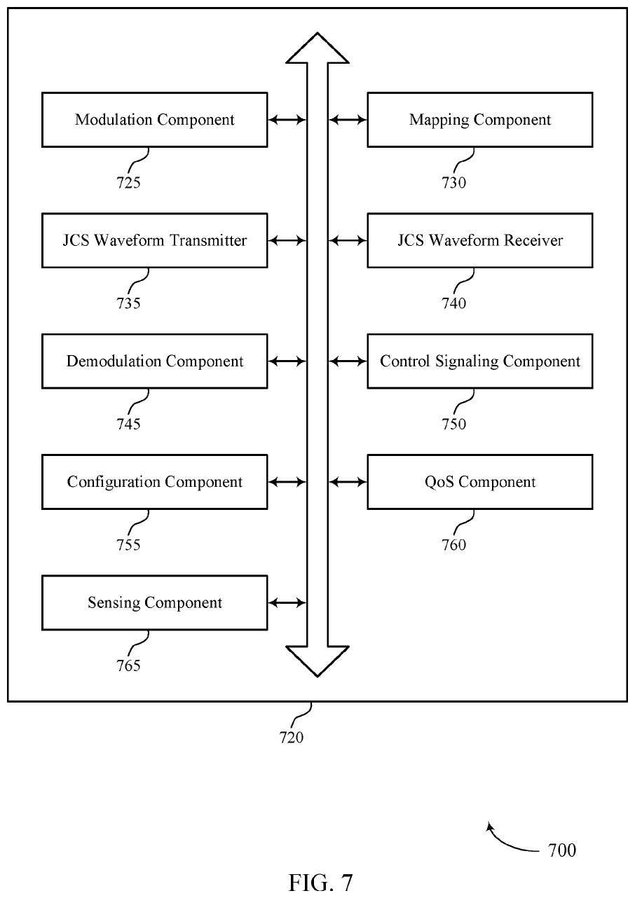

FIG. 7 shows a block diagram 700 of a communications manager 720 that supports constellation-based resource allocation for sensing and communication in accordance with one or more aspects of the present disclosure. The communications manager 720 may be an example of aspects of a communications manager 520, a communications manager 620, or both, as described herein. The communications manager 720, or various components thereof, may be an example of means for performing various aspects of constellation-based resource allocation for sensing and communication as described herein. For example, the communications manager 720 may include a modulation component 725, a mapping component 730, a JCS waveform transmitter 735, a JCS waveform receiver 740, a demodulation component 745, a control signaling component 750, a configuration component 755, a QoS component 760, a sensing component 765, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications at a wireless device in accordance with examples as disclosed herein. The modulation component 725 may be configured as or otherwise support a means for modulating a first portion of data of a transport block associated with a JCS waveform in accordance with a modulation scheme for sensing. The mapping component 730 may be configured as or otherwise support a means for mapping the modulated first portion of data to a first set of REs associated with sensing. In some examples, the mapping component 730 may be configured as or otherwise support a means for mapping a second portion of data to a second set of REs associated with data communications. The JCS waveform transmitter 735 may be configured as or otherwise support a means for transmitting the transport block including the mapped first portion of data and second portion of data via the JCS waveform.

In some examples, to support transmitting the transport block, the JCS waveform transmitter 735 may be configured as or otherwise support a means for transmitting the transport block in accordance with one or more parameters of a configuration for the JCS waveform.

In some examples, to support mapping the modulated first portion of data, the mapping component 730 may be configured as or otherwise support a means for mapping the modulated first portion of the data to the first set of REs according to the RE pattern.

In some examples, the one or more parameters include a transmit power for the first set of REs, and the JCS waveform transmitter 735 may be configured as or otherwise support a means for transmitting the first portion of data according to the transmit power. In some examples, the one or more parameters include a transmit power for the first set of REs, and the JCS waveform transmitter 735 may be configured as or otherwise support a means for transmitting the second portion of data according to a second transmit power different than the transmit power.

In some examples, the modulation component 725 may be configured as or otherwise support a means for modulating the second portion of data in accordance with a second modulation scheme for data communications, the second modulation scheme being different than the modulation scheme, where mapping the second portion of data to the second set of REs is based on the second modulation scheme.

In some examples, the wireless device is a first wireless device, and the control signaling component 750 may be configured as or otherwise support a means for transmitting, to a second wireless device, at least one message indicating one or more parameters of a configuration for the JCS waveform, the one or more parameters including the modulation scheme, a transmit power for the first set of REs, a transmit power for the second set of REs, an RE pattern for the first set of REs, a quantity of time domain resources for the configuration, a periodicity for the configuration, or a combination thereof. In some examples, the JCS waveform transmitter 735 may be configured as or otherwise support a means for transmitting the transport block via the JCS waveform in accordance with the configuration and the one or more parameters.

In some examples, to support transmitting the at least one message, the control signaling component 750 may be configured as or otherwise support a means for transmitting RRC signaling, DCI, SCI, a MAC-CE, or a combination thereof.

In some examples, to support transmitting the at least one message, the control signaling component 750 may be configured as or otherwise support a means for transmitting a first message indicating a first subset of the one or more parameters. In some examples, to support transmitting the at least one message, the control signaling component 750 may be configured as or otherwise support a means for transmitting a second message indicating a second subset of the one or more parameters.

In some examples, to support transmitting the at least one message, the control signaling component 750 may be configured as or otherwise support a means for transmitting an indication of a table corresponding to the one or more parameters.

In some examples, the at least one message further indicates a time duration for which the configuration is to be used, a system frame number corresponding to an end time of the configuration, or a combination thereof.

In some examples, the configuration component 755 may be configured as or otherwise support a means for updating at least one parameter of the one or more parameters of the configuration. In some examples, the control signaling component 750 may be configured as or otherwise support a means for transmitting, to the second wireless device, a signal indicating the updated at least one parameter.

In some examples, the wireless device is a first wireless device, and the control signaling component 750 may be configured as or otherwise support a means for transmitting, to a second wireless device, a signal indicating that the transport block is to be transmitted in accordance with a configuration for the JCS waveform and indicating one or more parameters supported by the first wireless device for the configuration.

In some examples, the control signaling component 750 may be configured as or otherwise support a means for receiving, from the second wireless device, a message indicating whether the second wireless device supports the configuration for the JCS waveform.

In some examples, the message indicates that the second wireless device supports the configuration for the JCS waveform and, to support indicates a set of parameters supported by the second wireless device for the configuration, and where transmitting the transport block, the configuration component 755 may be configured as or otherwise support a means for transmitting the transport block based on the set of parameters supported by the second wireless device.

In some examples, the wireless device is a first wireless device, and the configuration component 755 may be configured as or otherwise support a means for receiving, from a second wireless device, a message indicating one or more preferences of the second wireless device for the JCS waveform, where the transport block is transmitted in accordance with the one or more preferences based on receiving the message.

In some examples, to support receiving the message, the control signaling component 750 may be configured as or otherwise support a means for receiving RRC signaling or a feedback message.

In some examples, the wireless device is a first wireless device, and to support transmitting the transport block, the QoS component 760 may be configured as or otherwise support a means for transmitting the transport block via a communication link between the first wireless device and a second wireless device based on a QoS associated with the communication link.

In some examples, the QoS component 760 may be configured as or otherwise support a means for receiving control signaling indicating a mapping between one or more QoS values and one or more parameters for transmitting the JCS waveform, where transmitting the transport block is based on the mapping.

In some examples, the mapping component 730 may be configured as or otherwise support a means for refraining from mapping the modulated first portion of data to an RE of the first set of REs based on the RE overlapping with a reference signal RE for transmitting a reference signal.

In some examples, the sensing component 765 may be configured as or otherwise support a means for performing a sensing procedure using the reference signal RE and the first set of REs. In some examples, the sensing component 765 may be configured as or otherwise support a means for performing a sensing procedure using the first set of REs.

In some examples, the modulation scheme is from a set of modulation schemes, the set of modulation schemes including at least one of a PSK modulation scheme, a QPSK modulation scheme, and a constant-modulus modulation scheme.

Additionally, or alternatively, the communications manager 720 may support wireless communications at a wireless device in accordance with examples as disclosed herein. The JCS waveform receiver 740 may be configured as or otherwise support a means for receiving, via a JCS waveform, a transport block including a first portion of data and a second portion of data, the first portion of data received via a first set of REs associated with sensing and the second portion of data received via a second set of REs associated with data communications, the first portion of data being modulated in accordance with a modulation scheme for sensing. The demodulation component 745 may be configured as or otherwise support a means for demodulating the first portion of data and the second portion of data based on the modulation scheme.

In some examples, to support demodulating the first portion of data and the second portion of data, the demodulation component 745 may be configured as or otherwise support a means for demodulating the first portion of data according to the modulation scheme. In some examples, to support demodulating the first portion of data and the second portion of data, the demodulation component 745 may be configured as or otherwise support a means for demodulating the second portion of data according to the second modulation scheme.

In some examples, the wireless device is a first wireless device, and the control signaling component 750 may be configured as or otherwise support a means for receiving, from a second wireless device, at least one message indicating one or more parameters of a configuration for the JCS waveform, the one or more parameters including the modulation scheme, a transmit power for the first set of REs, a transmit power for the second set of REs, an RE pattern for the first set of REs, a quantity of time domain resource (slots/symbols) for the configuration, a periodicity for the configuration, or a combination thereof. In some examples, the JCS waveform receiver 740 may be configured as or otherwise support a means for receiving the transport block via the JCS waveform in accordance with the configuration and the one or more parameters.

In some examples, to support receiving the transport block, the JCS waveform receiver 740 may be configured as or otherwise support a means for receiving the first portion of data via the first set of REs in accordance with the RE pattern.

In some examples, to support receiving the at least one message, the control signaling component 750 may be configured as or otherwise support a means for receiving RRC signaling, DCI, SCI, a MAC-CE, or a combination thereof.

In some examples, to support receiving the at least one message, the control signaling component 750 may be configured as or otherwise support a means for receiving a first message indicating a first subset of the one or more parameters. In some examples, to support receiving the at least one message, the control signaling component 750 may be configured as or otherwise support a means for receiving a second message indicating a second subset of the one or more parameters.

In some examples, to support receiving the at least one message, the control signaling component 750 may be configured as or otherwise support a means for receiving an indication of a table corresponding to the one or more parameters.

In some examples, the at least one message further indicates a time duration for which the configuration is to be used, a system frame number corresponding to an end time of the configuration, or a combination thereof.

In some examples, the wireless device is a first wireless device, and the control signaling component 750 may be configured as or otherwise support a means for receiving, from a second wireless device, a signal indicating that the transport block is to be received via the JCS waveform and indicating one or more parameters supported by the second wireless device for the JCS waveform. In some examples, the control signaling component 750 may be configured as or otherwise support a means for transmitting, to the second wireless device, a message indicating whether the first wireless device supports the JCS waveform.

In some examples, the message indicates that the first wireless device supports the JCS waveform and indicates a set of parameters supported by the first wireless device for the JCS waveform.

In some examples, the wireless device is a first wireless device, and the control signaling component 750 may be configured as or otherwise support a means for transmitting, to a second wireless device, a message indicating one or more preferences of the first wireless device for the JCS waveform.

In some examples, to support transmitting the message, the control signaling component 750 may be configured as or otherwise support a means for transmitting RRC signaling or a feedback message.

In some examples, the modulation scheme is from a set of modulation schemes, the set of modulation schemes including at least one of a PSK modulation scheme, a QPSK modulation scheme, and a constant-modulus modulation scheme.

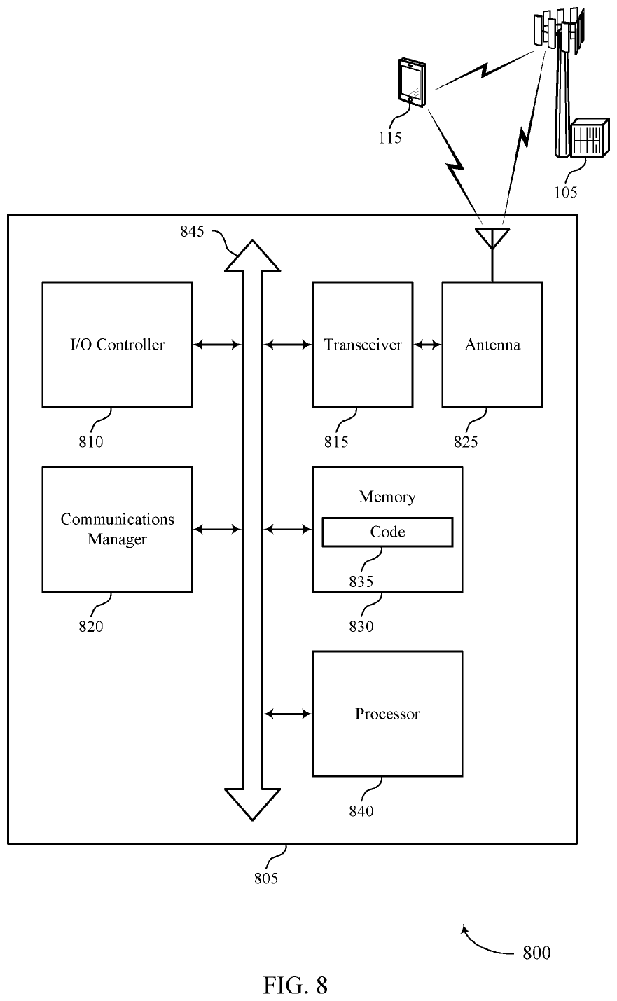

FIG. 8 shows a diagram of a system 800 including a device 805 that supports constellation-based resource allocation for sensing and communication in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting constellation-based resource allocation for sensing and communication). For example, the device 805 or a component of the device 805 may include a processor 840 and memory 830 coupled with or to the processor 840, the processor 840 and memory 830 configured to perform various functions described herein.

The communications manager 820 may support wireless communications at a wireless device in accordance with examples as disclosed herein. For example, the communications manager 820 may be configured as or otherwise support a means for modulating a first portion of data of a transport block associated with a JCS waveform in accordance with a modulation scheme for sensing. The communications manager 820 may be configured as or otherwise support a means for mapping the modulated first portion of data to a first set of REs associated with sensing. The communications manager 820 may be configured as or otherwise support a means for mapping a second portion of data to a second set of REs associated with data communications. The communications manager 820 may be configured as or otherwise support a means for transmitting the transport block including the mapped first portion of data and second portion of data via the JCS waveform.

Additionally, or alternatively, the communications manager 820 may support wireless communications at a wireless device in accordance with examples as disclosed herein. For example, the communications manager 820 may be configured as or otherwise support a means for receiving, via a JCS waveform, a transport block including a first portion of data and a second portion of data, the first portion of data received via a first set of REs associated with sensing and the second portion of data received via a second set of REs associated with data communications, the first portion of data being modulated in accordance with a modulation scheme for sensing. The communications manager 820 may be configured as or otherwise support a means for demodulating the first portion of data and the second portion of data based on the modulation scheme.

By including or configuring the communications manager 820 in accordance with examples as described herein, the device 805 may support techniques for reduced latency, more efficient utilization of time-frequency resources, and improved coordination between devices. For example, the device 805 may support reduced latency associated with reduced or optimized utilization of time-frequency resources for JCS communications. Additionally, by multiplexing modulation schemes for different portions of data within a transport block, the device 805 may support accurate sensing without negatively impacting data rate and throughput. For example, the device 805 may select a first modulation scheme for sensing REs, where the first modulation scheme provides increased accuracy and resolution for a sensing procedure. The device 805 may additionally select a second modulation scheme for data-only REs, which may support relatively high data rates and throughput.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of constellation-based resource allocation for sensing and communication as described herein, or the processor 840 and the memory 830 may be otherwise configured to perform or support such operations.

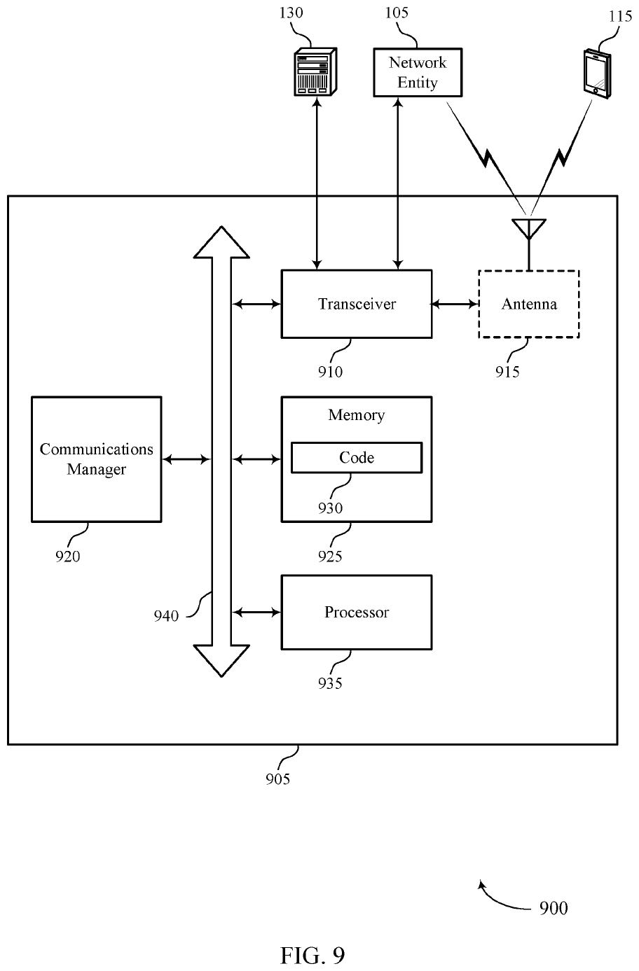

FIG. 9 shows a diagram of a system 900 including a device 905 that supports constellation-based resource allocation for sensing and communication in accordance with one or more aspects of the present disclosure. The device 905 may be an example of or include the components of a device 505, a device 605, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or memory components (for example, the processor 935, or the memory 925, or both), may be included in a chip or chip assembly that is installed in the device 905. The transceiver 910, or the transceiver 910 and one or more antennas 915 or wired interfaces, where applicable, may be an example of a transmitter 515, a transmitter 615, a receiver 510, a receiver 610, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting constellation-based resource allocation for sensing and communication). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905. The processor 935 may be any one or more suitable processors capable of executing scripts or instructions of one or more software programs stored in the device 905 (such as within the memory 925). In some implementations, the processor 935 may be a component of a processing system. A processing system may generally refer to a system or series of machines or components that receives inputs and processes the inputs to produce a set of outputs (which may be passed to other systems or components of, for example, the device 905). For example, a processing system of the device 905 may refer to a system including the various other components or subcomponents of the device 905, such as the processor 935, or the transceiver 910, or the communications manager 920, or other components or combinations of components of the device 905. The processing system of the device 905 may interface with other components of the device 905, and may process information received from other components (such as inputs or signals) or output information to other components. For example, a chip or modem of the device 905 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 905 may transmit information output from the chip or modem. In some implementations, the second interface may refer to an interface between the processing system of the chip or modem and a receiver, such that the device 905 may obtain information or signal inputs, and the information may be passed to the processing system. A person having ordinary skill in the art will readily recognize that the first interface also may obtain information or signal inputs, and the second interface also may output information or signal outputs.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communications at a wireless device in accordance with examples as disclosed herein. For example, the communications manager 920 may be configured as or otherwise support a means for modulating a first portion of data of a transport block associated with a JCS waveform in accordance with a modulation scheme for sensing. The communications manager 920 may be configured as or otherwise support a means for mapping the modulated first portion of data to a first set of REs associated with sensing. The communications manager 920 may be configured as or otherwise support a means for mapping a second portion of data to a second set of REs associated with data communications. The communications manager 920 may be configured as or otherwise support a means for transmitting the transport block including the mapped first portion of data and second portion of data via the JCS waveform.

Additionally, or alternatively, the communications manager 920 may support wireless communications at a wireless device in accordance with examples as disclosed herein. For example, the communications manager 920 may be configured as or otherwise support a means for receiving, via a JCS waveform, a transport block including a first portion of data and a second portion of data, the first portion of data received via a first set of REs associated with sensing and the second portion of data received via a second set of REs associated with data communications, the first portion of data being modulated in accordance with a modulation scheme for sensing. The communications manager 920 may be configured as or otherwise support a means for demodulating the first portion of data and the second portion of data based on the modulation scheme.

By including or configuring the communications manager 920 in accordance with examples as described herein, the device 905 may support techniques for more efficient utilization of communication resources and improved coordination between devices. For example, the device 905 may support more efficient utilization of communication resources by transmitting data via a JCS waveform. Accordingly, the device 905 may reduce the processing overhead at the device 905. Additionally, by modulating portions of data for the JCS waveform according to different modulation schemes, the device 905 may improve communications throughput while reducing interference and maintaining sensing accuracy.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the processor 935, the memory 925, the code 930, the transceiver 910, or any combination thereof. For example, the code 930 may include instructions executable by the processor 935 to cause the device 905 to perform various aspects of constellation-based resource allocation for sensing and communication as described herein, or the processor 935 and the memory 925 may be otherwise configured to perform or support such operations.

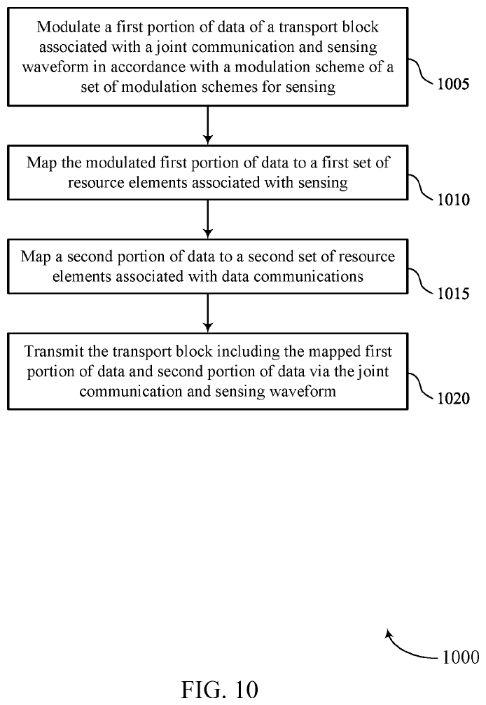

FIG. 10 shows a flowchart illustrating a method 1000 that supports constellation-based resource allocation for sensing and communication in accordance with one or more aspects of the present disclosure. The operations of the method 1000 may be implemented by a UE or a network entity or its components as described herein. For example, the operations of the method 1000 may be performed by a UE 115 or a network entity as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1005, the method may include modulating a first portion of data of a transport block associated with a JCS waveform in accordance with a modulation scheme for sensing. The operations of 1005 may be performed in accordance with examples as disclosed herein. In some examples, aspects of the operations of 1005 may be performed by a modulation component 725 as described with reference to FIG. 7.

At 1010, the method may include mapping the modulated first portion of data to a first set of REs associated with sensing. The operations of 1010 may be performed in accordance with examples as disclosed herein. In some examples, aspects of the operations of 1010 may be performed by a mapping component 730 as described with reference to FIG. 7.

At 1015, the method may include mapping a second portion of data to a second set of REs associated with data communications. The operations of 1015 may be performed in accordance with examples as disclosed herein. In some examples, aspects of the operations of 1015 may be performed by a mapping component 730 as described with reference to FIG. 7.

At 1020, the method may include transmitting the transport block including the mapped first portion of data and second portion of data via the JCS waveform. The operations of 1020 may be performed in accordance with examples as disclosed herein. In some examples, aspects of the operations of 1020 may be performed by a JCS waveform transmitter 735 as described with reference to FIG. 7.

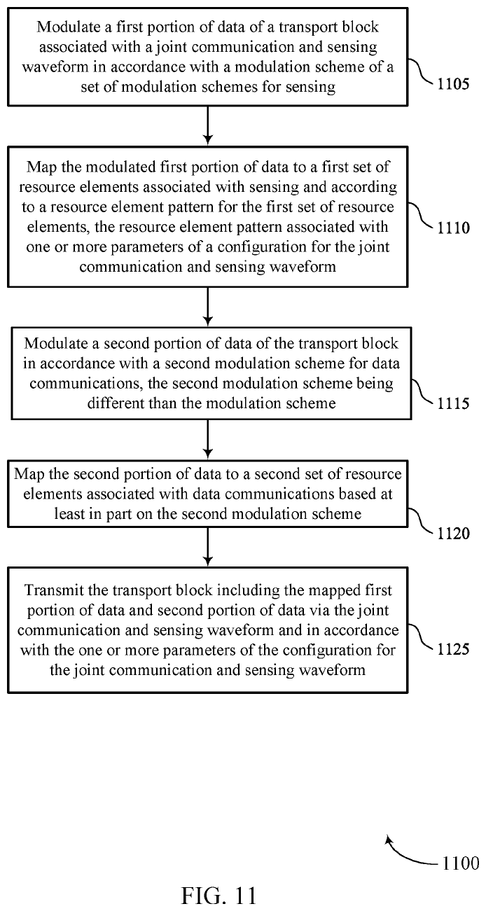

FIG. 11 shows a flowchart illustrating a method 1100 that supports constellation-based resource allocation for sensing and communication in accordance with one or more aspects of the present disclosure. The operations of the method 1100 may be implemented by a UE or a network entity or its components as described herein. For example, the operations of the method 1100 may be performed by a UE 115 or a network entity as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include modulating a first portion of data of a transport block associated with a JCS waveform in accordance with a modulation scheme for sensing. The operations of 1105 may be performed in accordance with examples as disclosed herein. In some examples, aspects of the operations of 1105 may be performed by a modulation component 725 as described with reference to FIG. 7.

At 1110, the method may include mapping the modulated first portion of data to a first set of REs associated with sensing and according to an RE pattern for the first set of REs, the RE pattern associated with one or more parameters of a configuration for the JCS waveform. The operations of 1110 may be performed in accordance with examples as disclosed herein. In some examples, aspects of the operations of 1110 may be performed by a mapping component 730 as described with reference to FIG. 7.

At 1115, the method may include modulating the second portion of data in accordance with a second modulation scheme for data communications, the second modulation scheme being different than the modulation scheme. The operations of 1115 may be performed in accordance with examples as disclosed herein. In some examples, aspects of the operations of 1115 may be performed by a modulation component 725 as described with reference to FIG. 7.

At 1120, the method may include mapping a second portion of data to a second set of REs associated with data communications based on the second modulation scheme. The operations of 1120 may be performed in accordance with examples as disclosed herein. In some examples, aspects of the operations of 1120 may be performed by a mapping component 730 as described with reference to FIG. 7.

At 1125, the method may include transmitting the transport block including the mapped first portion of data and second portion of data via the JCS waveform and in accordance with the one or more parameters of the configuration for the JCS waveform. The operations of 1125 may be performed in accordance with examples as disclosed herein. In some examples, aspects of the operations of 1125 may be performed by a JCS waveform transmitter 735 as described with reference to FIG. 7.

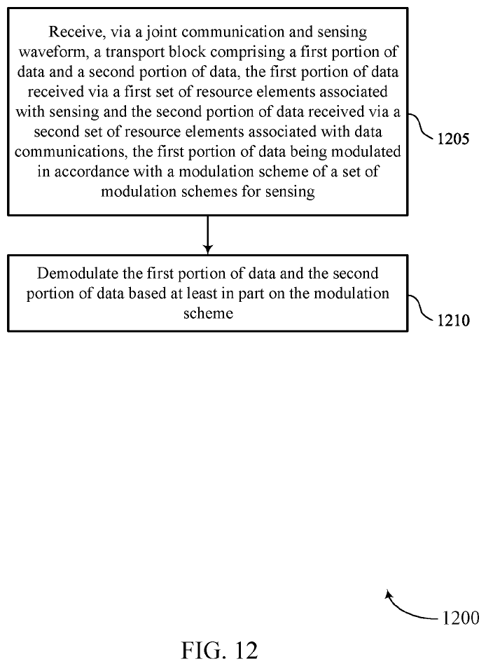

FIG. 12 shows a flowchart illustrating a method 1200 that supports constellation-based resource allocation for sensing and communication in accordance with one or more aspects of the present disclosure. The operations of the method 1200 may be implemented by a UE or a network entity or its components as described herein. For example, the operations of the method 1200 may be performed by a UE 115 or a network entity as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include receiving, via a JCS waveform, a transport block including a first portion of data and a second portion of data, the first portion of data received via a first set of REs associated with sensing and the second portion of data received via a second set of REs associated with data communications, the first portion of data being modulated in accordance with a modulation scheme for sensing. The operations of 1205 may be performed in accordance with examples as disclosed herein. In some examples, aspects of the operations of 1205 may be performed by a JCS waveform receiver 740 as described with reference to FIG. 7.

At 1210, the method may include demodulating the first portion of data and the second portion of data based on the modulation scheme. The operations of 1210 may be performed in accordance with examples as disclosed herein. In some examples, aspects of the operations of 1210 may be performed by a demodulation component 745 as described with reference to FIG. 7.

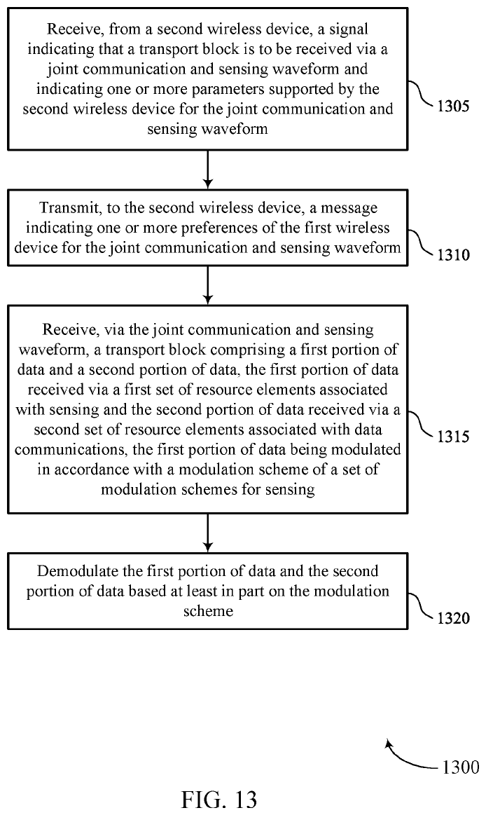

FIG. 13 shows a flowchart illustrating a method 1300 that supports constellation-based resource allocation for sensing and communication in accordance with one or more aspects of the present disclosure. The operations of the method 1300 may be implemented by a UE or a network entity or its components as described herein. For example, the operations of the method 1300 may be performed by a UE 115 or a network entity as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include receiving, from a second wireless device, a signal indicating that a transport block is to be received via a JCS waveform and indicating one or more parameters supported by the second wireless device for the JCS waveform. The operations of 1305 may be performed in accordance with examples as disclosed herein. In some examples, aspects of the operations of 1305 may be performed by a control signaling component 750 as described with reference to FIG. 7.

At 1310, the method may include transmitting, to the second wireless device, a message indicating one or more preferences of the wireless device for the JCS waveform. The operations of 1310 may be performed in accordance with examples as disclosed herein. In some examples, aspects of the operations of 1310 may be performed by a control signaling component 750 as described with reference to FIG. 7.

At 1315, the method may include receiving, via the JCS waveform, the transport block including a first portion of data and a second portion of data, the first portion of data received via a first set of REs associated with sensing and the second portion of data received via a second set of REs associated with data communications, the first portion of data being modulated in accordance with a modulation scheme for sensing. The operations of 1315 may be performed in accordance with examples as disclosed herein. In some examples, aspects of the operations of 1315 may be performed by a JCS waveform receiver 740 as described with reference to FIG. 7.

At 1320, the method may include demodulating the first portion of data and the second portion of data based on the modulation scheme. The operations of 1320 may be performed in accordance with examples as disclosed herein. In some examples, aspects of the operations of 1320 may be performed by a demodulation component 745 as described with reference to FIG. 7.

The following provides an overview of aspects of the present disclosure:

Aspect 1: A method for wireless communications at a wireless device, comprising: modulating a first portion of data of a transport block associated with a JCS waveform in accordance with a modulation scheme for sensing: mapping the modulated first portion of data to a first set of REs associated with sensing: mapping a second portion of data to a second set of REs associated with data communications: and transmitting the transport block including the mapped first portion of data and second portion of data via the JCS waveform.

Aspect 2: The method of aspect 1, wherein transmitting the transport block comprises: transmitting the transport block in accordance with one or more parameters of a configuration for the JCS waveform.

Aspect 3: The method of aspect 2, wherein the one or more parameters comprise an RE pattern for the first set of REs, and wherein mapping the modulated first portion of data comprises: mapping the modulated first portion of the data to the first set of REs according to the RE pattern.

Aspect 4: The method of any of aspects 2 through 3, wherein the one or more parameters comprise a transmit power for the first set of REs, the method further comprising: transmitting the first portion of data according to the transmit power: and transmitting the second portion of data according to a second transmit power different than the transmit power.

Aspect 5: The method of any of aspects 1 through 4, further comprising: modulating the second portion of data in accordance with a second modulation scheme for data communications, the second modulation scheme being different than the modulation scheme, wherein mapping the second portion of data to the second set of REs is based at least in part on the second modulation scheme.

Aspect 6: The method of any of aspects 1 through 5, wherein the wireless device is a first wireless device, further comprising: transmitting, to a second wireless device, at least one message indicating one or more parameters of a configuration for the JCS waveform, the one or more parameters comprising the modulation scheme, a transmit power for the first set of REs, a transmit power for the second set of REs, an RE pattern for the first set of RES, a quantity of time domain resources for the configuration, a periodicity for the configuration, or a combination thereof; and transmitting the transport block via the JCS waveform in accordance with the configuration and the one or more parameters.

Aspect 7: The method of aspect 6, wherein transmitting the at least one message comprises: transmitting RRC signaling, DCI, SCI, a MAC-CE, or a combination thereof.

Aspect 8: The method of any of aspects 6 through 7, wherein transmitting the at least one message comprises: transmitting a first message indicating a first subset of the one or more parameters: and transmitting a second message indicating a second subset of the one or more parameters.

Aspect 9: The method of any of aspects 6 through 8, wherein transmitting the at least one message comprises: transmitting an indication of a table corresponding to the one or more parameters.

Aspect 10: The method of any of aspects 6 through 9, wherein the at least one message further indicates a time duration for which the configuration is to be used, a system frame number corresponding to an end time of the configuration, or a combination thereof.

Aspect 11: The method of any of aspects 6 through 10, further comprising: updating at least one parameter of the one or more parameters of the configuration: and transmitting, to the second wireless device, a signal indicating the updated at least one parameter.

Aspect 12: The method of any of aspects 1 through 11, wherein the wireless device is a first wireless device, further comprising: transmitting, to a second wireless device, a signal indicating that the transport block is to be transmitted in accordance with a configuration for the JCS waveform and indicating one or more parameters supported by the first wireless device for the configuration.

Aspect 13: The method of aspect 12, further comprising: receiving, from the second wireless device, a message indicating whether the second wireless device supports the configuration for the JCS waveform.

Aspect 14: The method of aspect 13, wherein the message indicates that the second wireless device supports the configuration for the JCS waveform and indicates a set of parameters supported by the second wireless device for the configuration, and wherein transmitting the transport block comprises: transmitting the transport block based at least in part on the set of parameters supported by the second wireless device.

Aspect 15: The method of any of aspects 1 through 14, wherein the wireless device is a first wireless device, further comprising: receiving, from a second wireless device, a message indicating one or more preferences of the second wireless device for the JCS waveform, wherein the transport block is transmitted in accordance with the one or more preferences based at least in part on receiving the message.

Aspect 16: The method of aspect 15, wherein receiving the message comprises: receiving RRC signaling or a feedback message.

Aspect 17: The method of any of aspects 1 through 16, wherein the wireless device is a first wireless device, and wherein transmitting the transport block comprises: transmitting the transport block via a communication link between the first wireless device and a second wireless device based at least in part on a quality of service associated with the communication link.

Aspect 18: The method of aspect 17, further comprising: receiving control signaling indicating a mapping between one or more quality of service values and one or more parameters for transmitting the JCS waveform, wherein transmitting the transport block is based at least in part on the mapping.

Aspect 19: The method of any of aspects 1 through 18, further comprising: refraining from mapping the modulated first portion of data to an RE of the first set of REs based at least in part on the RE overlapping with a reference signal RE for transmitting a reference signal.

Aspect 20: The method of aspect 19, further comprising: performing a sensing procedure using the reference signal RE and the first set of REs.

Aspect 21: The method of any of aspects 1 through 20, further comprising: performing a sensing procedure using the first set of RES.

Aspect 22: The method of any of aspects 1 through 21, wherein the modulation scheme is from a set of modulation schemes, the set of modulation schemes comprising at least one of a PSK modulation scheme, a QPSK modulation scheme, and a constant-modulus modulation scheme.

Aspect 23: A method for wireless communications at a wireless device, comprising: receiving, via a JCS waveform, a transport block comprising a first portion of data and a second portion of data, the first portion of data received via a first set of REs associated with sensing and the second portion of data received via a second set of REs associated with data communications, the first portion of data being modulated in accordance with a modulation scheme for sensing: and demodulating the first portion of data and the second portion of data based at least in part on the modulation scheme.

Aspect 24: The method of aspect 23, wherein the second portion of data is modulated in accordance with a second modulation scheme, and wherein demodulating the first portion of data and the second portion of data further comprises: demodulating the first portion of data according to the modulation scheme: and demodulating the second portion of data according to the second modulation scheme.

Aspect 25: The method of any of aspects 23 through 24, wherein the wireless device is a first wireless device, further comprising: receiving, from a second wireless device, at least one message indicating one or more parameters of a configuration for the JCS waveform, the one or more parameters comprising the modulation scheme, a transmit power for the first set of REs, a transmit power for the second set of REs, an RE pattern for the first set of REs, a quantity of time domain resources for the configuration, a periodicity for the configuration, or a combination thereof: and receiving the transport block via the JCS waveform in accordance with the configuration and the one or more parameters.

Aspect 26: The method of aspect 25, wherein the one or more parameters comprise an RE pattern for the first set of REs, and wherein receiving the transport block comprises: receiving the first portion of data via the first set of REs in accordance with the RE pattern.

Aspect 27: The method of any of aspects 25 through 26, wherein receiving the at least one message comprises: receiving RRC signaling, DCI, SCI, a MAC-CE, or a combination thereof.

Aspect 28: The method of any of aspects 25 through 27, wherein receiving the at least one message comprises: receiving a first message indicating a first subset of the one or more parameters: and receiving a second message indicating a second subset of the one or more parameters.

Aspect 29: The method of any of aspects 25 through 28, wherein receiving the at least one message comprises: receiving an indication of a table corresponding to the one or more parameters.

Aspect 30: The method of any of aspects 25 through 29, wherein the at least one message further indicates a time duration for which the configuration is to be used, a system frame number corresponding to an end time of the configuration, or a combination thereof.

Aspect 31: The method of any of aspects 23 through 30, wherein the wireless device is a first wireless device, further comprising: receiving, from a second wireless device, a signal indicating that the transport block is to be received via the JCS waveform and indicating one or more parameters supported by the second wireless device for the JCS waveform.

Aspect 32: The method of aspect 31, further comprising: transmitting, to the second wireless device, a message indicating whether the first wireless device supports the JCS waveform.

Aspect 33: The method of aspect 32, wherein the message indicates that the first wireless device supports the JCS waveform and indicates a set of parameters supported by the first wireless device for the JCS waveform.

Aspect 34: The method of any of aspects 23 through 33, wherein the wireless device is a first wireless device, further comprising: transmitting, to a second wireless device, a message indicating one or more preferences of the first wireless device for the JCS waveform.

Aspect 35: The method of aspect 34, wherein transmitting the message comprises: transmitting RRC signaling or a feedback message.

Aspect 36: The method of any of aspects 23 through 35, wherein the modulation scheme is from a set of modulation schemes, the set of modulation schemes comprising at least one of a PSK modulation scheme, a QPSK modulation scheme, and a constant-modulus modulation scheme.

Aspect 37: An apparatus for wireless communications at a wireless device, comprising a processor: memory coupled with the processor: and instructions stored in the memory and executable by the processor to cause the apparatus to perform a method of any of aspects 1 through 22.

Aspect 38: An apparatus for wireless communications at a wireless device, comprising at least one means for performing a method of any of aspects 1 through 22.

Aspect 39: A non-transitory computer-readable medium storing code for wireless communications at a wireless device, the code comprising instructions executable by a processor to perform a method of any of aspects 1 through 22.

Aspect 40: An apparatus for wireless communications at a wireless device, comprising a processor: memory coupled with the processor: and instructions stored in the memory and executable by the processor to cause the apparatus to perform a method of any of aspects 23 through 36.

Aspect 41: An apparatus for wireless communications at a wireless device, comprising at least one means for performing a method of any of aspects 23 through 36.

Aspect 42: A non-transitory computer-readable medium storing code for wireless communications at a wireless device, the code comprising instructions executable by a processor to perform a method of any of aspects 23 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a wireless device, comprising:
modulating a first portion of data of a transport block associated with a joint communication and sensing waveform in accordance with a modulation scheme for sensing;
mapping the modulated first portion of data to a first set of resource elements associated with sensing;
mapping a second portion of data to a second set of resource elements associated with data communications; and
transmitting the transport block including the mapped first portion of data and second portion of data via the joint communication and sensing waveform.

2. The method of claim 1, wherein transmitting the transport block comprises:
transmitting the transport block in accordance with one or more parameters of a configuration for the joint communication and sensing waveform.

3. The method of claim 2, wherein the one or more parameters comprise a resource element pattern for the first set of resource elements, and wherein mapping the modulated first portion of data comprises:
mapping the modulated first portion of the data to the first set of resource elements according to the resource element pattern.

4. (canceled)

5. The method of claim 1, further comprising:
modulating the second portion of data in accordance with a second modulation scheme for data communications, the second modulation scheme being different than the modulation scheme, wherein mapping the second portion of data to the second set of resource elements is based at least in part on the second modulation scheme.

6. The method of claim 1, wherein the wireless device is a first wireless device, the method further comprising:
transmitting, to a second wireless device, at least one message indicating one or more parameters of a configuration for the joint communication and sensing waveform, the one or more parameters comprising the modulation scheme, a transmit power for the first set of resource elements, a transmit power for the second set of resource elements, a resource element pattern for the first set of resource elements, a quantity of time domain resources for the configuration, a periodicity for the configuration, or a combination thereof; and
transmitting the transport block via the joint communication and sensing waveform in accordance with the configuration and the one or more parameters.

7-9. (canceled)

10. The method of claim 6, wherein the at least one message further indicates a time duration for which the configuration is to be used, a system frame number corresponding to an end time of the configuration, or a combination thereof.

11. (canceled)

12. The method of claim 1, wherein the wireless device is a first wireless device, the method further comprising:
transmitting, to a second wireless device, a signal indicating that the transport block is to be transmitted in accordance with a configuration for the joint communication and sensing waveform and indicating one or more parameters supported by the first wireless device for the configuration.

13. The method of claim 12, further comprising:
receiving, from the second wireless device, a message indicating whether the second wireless device supports the configuration for the joint communication and sensing waveform.

14. The method of claim 13, wherein the message indicates that the second wireless device supports the configuration for the joint communication and sensing waveform and indicates a set of parameters supported by the second wireless device for the configuration, and wherein transmitting the transport block comprises:
transmitting the transport block based at least in part on the set of parameters supported by the second wireless device.

15. The method of claim 1, wherein the wireless device is a first wireless device, the method further comprising:
receiving, from a second wireless device, a message indicating one or more preferences of the second wireless device for the joint communication and sensing waveform, wherein the transport block is transmitted in accordance with the one or more preferences based at least in part on receiving the message.

16. (canceled)

17. The method of claim 1, wherein the wireless device is a first wireless device, and wherein transmitting the transport block comprises:
transmitting the transport block via a communication link between the first wireless device and a second wireless device based at least in part on a quality of service associated with the communication link.

18. The method of claim 17, further comprising:
receiving control signaling indicating a mapping between one or more quality of service values and one or more parameters for transmitting the joint communication and sensing waveform, wherein transmitting the transport block is based at least in part on the mapping.

19. The method of claim 1, further comprising:
refraining from mapping the modulated first portion of data to a resource element of the first set of resource elements based at least in part on the resource element overlapping with a reference signal resource element for transmitting a reference signal.

20. The method of claim 1, wherein the modulation scheme is from a set of modulation schemes, the set of modulation schemes comprising at least one of a phase shift keying modulation scheme, a quadrature phase shift keying modulation scheme, and a constant-modulus modulation scheme.

21. A method for wireless communications at a wireless device, comprising:
receiving, via a joint communication and sensing waveform, a transport block comprising a first portion of data and a second portion of data, the first portion of data received via a first set of resource elements associated with sensing and the second portion of data received via a second set of resource elements associated with data communications, the first portion of data being modulated in accordance with a modulation scheme for sensing; and
demodulating the first portion of data and the second portion of data based at least in part on the modulation scheme.

22. The method of claim 21, wherein the second portion of data is modulated in accordance with a second modulation scheme, and wherein demodulating the first portion of data and the second portion of data further comprises:
demodulating the first portion of data according to the modulation scheme; and
demodulating the second portion of data according to the second modulation scheme.

23. The method of claim 21, wherein the wireless device is a first wireless device, the method further comprising:
receiving, from a second wireless device, at least one message indicating one or more parameters of a configuration for the joint communication and sensing waveform, the one or more parameters comprising the modulation scheme, a transmit power for the first set of resource elements, a transmit power for the second set of resource elements, a resource element pattern for the first set of resource elements, a quantity of time domain resource (slots/symbols) for the configuration, a periodicity for the configuration, or a combination thereof; and
receiving the transport block via the joint communication and sensing waveform in accordance with the configuration and the one or more parameters.

24-26. (canceled)

27. The method of claim 21, wherein the wireless device is a first wireless device, the method further comprising:
receiving, from a second wireless device, a signal indicating that the transport block is to be received via the joint communication and sensing waveform and indicating one or more parameters supported by the second wireless device for the joint communication and sensing waveform.

28. The method of claim 27, further comprising:
transmitting, to the second wireless device, a message indicating whether the first wireless device supports the joint communication and sensing waveform.

29. An apparatus for wireless communications at a wireless device, comprising:
a processor;
memory coupled with the processor; and
instructions stored in the memory and executable by the processor to cause the apparatus to:
modulate a first portion of data of a transport block associated with a joint communication and sensing waveform in accordance with a modulation scheme for sensing;
map the modulated first portion of data to a first set of resource elements associated with sensing;
map a second portion of data to a second set of resource elements associated with data communications; and
transmit the transport block including the mapped first portion of data and second portion of data via the joint communication and sensing waveform.

30. (canceled)
